(19) United States
(12) Patent Application Publication
(10) Pub. No.: US 2017/0244841 A1
(43) Pub. Date: Aug. 24, 2017

(54) METHODS, SYSTEMS, AND APPARATUS FOR CONTROLLING A MOBILE

(71) Applicants: Wisam Costandi, Doha (QA); Frederik Albrechtsen, Dubai (AE)

(72) Inventors: Wisam Costandi, Doha (QA); Frederik Albrechtsen, Dubai (AE)

(21) Appl. No.: 15/438,897

(22) Filed: Feb. 22, 2017

Related U.S. Application Data
(60) Provisional application No. 62/298,243, filed on Feb. 22, 2016.

(51) Int. Cl. H04M 11/00; H04W 4/02; H04W 4/14; H04W 12/08

(52) U.S. Cl. CPC H04M 11/007; H04W 12/08; H04W 4/021; H04W 4/14; H04L 65/608

(57) ABSTRACT

Methods and systems are disclosed for controlling and monitoring mobile devices and the intercommunication between devices. In one example, the control and monitoring may be performed between and child's mobile device and a parent's mobile device such that the parent may limit the ability of the child to access contacts, application, and other functions associated with a mobile device

This application claims priority to provisional application No. 62/298,243 filed on Feb. 22, 2016, the disclosure of which is incorporated herein by reference in its entirety.

### TECHNICAL FIELD

This application relates in general to controlling and monitoring mobile devices, and more particularly, to controlling access and monitoring content and communication on a mobile device.

### BACKGROUND

Wireless communication systems are available that provide various types of media and communication content such as, voice, data, graphics, pictures, video, etc. Such systems are typically multiple-access systems that allow multiple users to share resources.

Wireless communication systems can support mobile devices that communicate with one or more base stations using downlinks to communicate from the base station to the mobile device and uplinks from the mobile device to base stations.

Mobile devices have become commonplace among adults and children and are used for personal and professional reasons. Mobile devices can be used for sending messages, making phone calls, and accessing and executing a variety of software applications.

Mobile devices may send text messages using a Short Message Service (SMS) application that allows users of mobile devices to send and receive text messages. Mobile devices may also use a Multimedia Message Service (MMS) application to enable users to send and receive multimedia content, such as text, graphics, digital photographs, audio files and video clips. Mobile devices supporting MMS allow users to send multimedia content in one or more parts or in one or more messages to one or more recipients.

MMS technology and/or the intelligence of mobile devices, i.e., smartphones, essentially brings multimedia content previously only available on television and/or via computer to mobile users. This increases the risk of access to unwanted, dangerous, or inappropriate to minors. To date, existing tools are known that allow parents or adults to limit or monitor to the content provided to minors by collaborating with the relevant service providers. For example, cable television providers allow parents to set up codes blocking access to content via a set-top box or use labeling to notify adults of the content no appropriate to minors. Internet providers use V-chip technology, filters or settings to block certain content from minors.

While these technologies and collaborations may work for a majority of situations involving cable or computer applications, MMS and SMS applications are private and sent between users. Accordingly, they cannot be easily monitored by providers or parents, unless significant time and resources are dedicated. Moreover, such monitoring may impact privacy concerns where applicable.

Additionally, independent device manufacturers require access to an embedded technology that allows for monitoring or protection of minors as an overlay to an existing device operating system.

Accordingly, there is a need for a simple, discrete method and system to access, monitor, and allow or prevent content from becoming available to minors without approval from a qualified adult or parent.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is an example architectural diagram of an embodiment.

FIG. 2 illustrates an architecture in one embodiment.

FIGS. 3A-3B shows a communication flow for a parent and child registration.

FIG. 4 shows the parent registration in an embodiment.

FIG. 5 shows the child registration in an embodiment.

FIG. 6 shows the parent-child mobile device bonding in an embodiment.

FIG. 7 shows the authentication module in an embodiment.

FIG. 8 shows dashboard updates in an embodiment . . . .

FIG. 9A shows the contact module for the child in an embodiment.

FIG. 9B shows the contact module for a secondary parent in an embodiment.

FIG. 10 shows the contact module for the parent in an embodiment.

FIGS. 11A and 11B show the SMS module in an embodiment.

FIGS. 12A and 12B show the location module in an embodiment.

FIGS. 13A and 13B show the call-log in module in an embodiment.

FIG. 14 shows the activity module in an embodiment.

FIGS. 15A-15B show the applications module in an embodiment.

FIG. 16 shows the parent re-login in an embodiment.

FIG. 17 shows a parent mobile device in an embodiment.

FIG. 18 shows a child mobile device in an embodiment.

FIG. 19 shows updating a parent dashboard from the child device in an embodiment.

FIG. 20 shows a flow for adding another child device to the parent application in an embodiment.

FIG. 21 shows live tracking for the child device in an embodiment.

FIG. 22 shows live tracking for the parent device in an embodiment.

FIGS. 23-24 show an activity monitor for a child device updating activity.

FIG. 25 shows geo-fencing in an embodiment.

FIG. 26 shows In App purchases in an embodiment.

FIG. 27 shows Parent-Child messaging using Sinch service in an embodiment.

Like reference symbols in the various drawings indicate like elements.

### SUMMARY OF INVENTION

In one aspect, a system for controlling a second mobile device from a first mobile device, the system comprising: one or more processors; and a machine-readable medium comprising instructions stored therein, which when executed by the processors, cause the processors to perform operations comprising: receiving by a processor of the first mobile device a request to approve a contact transmitted by the second mobile device, approving by the processor of the first computing device the contact by pushing the approval to a processor of the second computing device; monitoring by the processor of the first mobile device an amount of time that the contact is in communication with the second mobile device; and adding a second contact by the processor of the first mobile device directly to the second mobile device from the first mobile device.

In another aspect, a computer-implemented method for controlling a second mobile device from a first mobile device, comprising receiving by a processor of the first mobile device a request to approve a contact transmitted by the second mobile device, approving by the processor of the first computing device the contact by pushing the approval to a processor of the second computing device; monitoring by the processor of the first mobile device an amount of time that the contact is in communication with the second mobile device; and adding a second contact by the processor of the first mobile device directly to the second mobile device from the first mobile device.

The system and methods may comprise requesting by the processor of the first mobile device a status of the second mobile device, wherein the status comprises one of the location of the second mobile device, an activity of the second mobile device, applications being executed by the second mobile device, and information associated with geo-fencing for the second mobile device.

The system and methods may comprise locking access to one or more software applications executing on the processor of the second computing device. The system and methods may comprise presenting by the processor of the first mobile device a visual slider associated with activity of the second mobile device. The system and methods may comprise monitoring by the processor of the first mobile device the activity of the second mobile device in real-time or substantially real-time.

The system and methods may comprise controlling access to one or more applications executing on the processor of the second mobile device by the processor of the first computing device based on one of timing, geo-location, location, schedule, and usage. The system and methods may comprise, wherein the processor of the first mobile device and the processor of the second computing device are in communication with a cloud platform.

The system and methods may comprise sending by the processor of the second mobile device a Short Message Service (SMS) to first mobile device indicating a location of the second mobile device when second mobile device is not in communication with a network. The system and methods may comprise approving by the processor a third mobile device to be in communication with the second mobile device. The system and methods may comprise accessing one or more SMS messages present on the second mobile device by the processor of the first mobile device.

### DETAILED DESCRIPTION

Each of the additional features and teachings disclosed below can be utilized separately or in conjunction with other features and teachings to provide a device, system, and/or method for controlling access and monitoring content and communication on a mobile device. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for providing controls to content available to a child on a mobile device. Content may include text, audio, video, graphics and any other content that may be transmitted, received, and/or stored on a mobile device. A mobile device may be any portable device that has wireless capabilities for executing one or more software applications. Further, the systems, apparatus, and methods of the inventions described herein contemplate control over a relationship between two persons or entities or both. Accordingly, in one embodiment, the relationship may be between parent and child. In other embodiments, it may be between an employer and employee. In other embodiments, it may be between two companies. It should be noted that references to “child,” “child application,” and “child's side” are meant to refer to an application runs on a child's mobile device using software, hardware, or a combination thereof. It should be noted that references to “parent,” “parent application,” and “parent's side” are meant to refer to an application runs on a child's mobile device using software, hardware, or a combination thereof. Additionally, the terms “child” and “kid” are interchangeable. It should also be noted that the monitoring may be performed in real time or substantially real time.

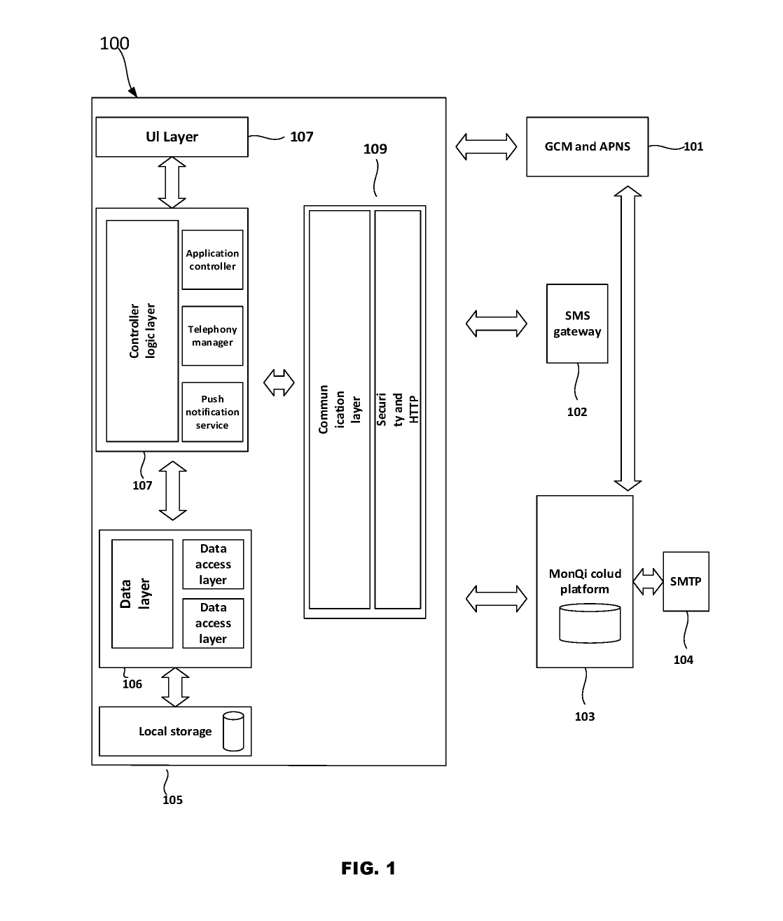

FIG. 1 shows an exemplary implementation of an architecture or system 100 in an embodiment. The architecture 100 may include user interface (UI) layer 108 that interfaces with a control logic layer 107. The UI layer 108 may be configured to construct one or more interfaces of an application running on a mobile device. The UI layer 108 may include components necessary for the user to view and interact with the underlying application. The UI layer 108 communicates with the Application controller which in turn communicates with the other layers in the system 106,109.

As shown in FIG. 1, the control logic layer 107 may be configured to control the flow of data to and from the UI layer 108 and to the underlying data layer 106 and the communication layer 109. The communication layer 109 may include one or more push notification servers and provide communication with the cloud platform 103. The control logic layer may be configured to enable phone calls, establish data connections, and provide navigation to various screens on the mobile device.

The control logic layer may include a telephony manager to define the telephony services of the mobile device, a push notification service that allows information from the application to be delivered to the mobile device without a specific request, and an application controller, which may be used to ensure only desired applications are executing on the mobile device.

Referring again to FIG. 1, the system 100 may include a data layer 106, which includes data related to the application and may use one or more databases to store the data in local storage 105. In some embodiments, the data layer may use encryption on the data. The following are examples of encryption techniques.

AES Encryption in Android:
The data is encrypted using AES-256 encryption method.
The library used to achieve is Bouncy Castle.
256 bit key will be used

Sample Code for Encryption in Android:
// AES algorithm with CBC cipher and PKCS5 padding
Cipher cipher=Cipher.getInstance(“AES/CBC/PKCS5Padding”, “BC”);
// Construct AES key from salt and 50 iterations
PBEKeySpec pbeEKeySpec=new
PBEKeySpec(password.toCharArray( ), toByte(salt), 50, 256);
SecretKeyFactory keyFactory=
SecretKeyFactory.getInstance(“PBEWithSHA256And256BitAES-CBC-BC”);
SecretKeySpec secretKey=new
SecretKeySpec(keyFactory.generateSecret(pbeEKeySpec).getEncoded( ),

AES Encryption in iOS:
AES-256 encryption will be used to store data in local database
Security.framework will be used to achieve AES-256
256 bit key will be used
Generated key will be stored in keychain which Apple recommended for storing password and all, which is not available to any other application

Sample Code for Key Generation in iOS:
*salt=[self randomDataOfLength:kPBKDFSaltSize]; NSData *key=[self
AESKeyForPassword:password salt:*salt]

The system 100 may also include communication layer 109 that is configured to handle all communications with the backend of the system as described above. The communications layer 109 may use certain security requirements necessary to protect the flow of data in the system. The communications layer 109 may also keep configuration details for different types of communications.

As shown in the FIG. 1, communication layer 109 has an interconnection between controller logic layer and communication layer itself. Controller logic may include communication services, such as Telephony manager and push notification service. Telephony manager may be used for SMS sending and receiving information between devices. Push notification may be used to transfer data between mobile devices, such as MonQiParent and MonQiKid. Since the communication layer is interconnected with controller logic layer. it will keep the configuration detail related to above communication process.

Referring again to FIG. 1, the system may include cloud platform 103 that provides the communication and any relationships or links between child and parent mobile devices and facilitates the communication between the various devices.

Following are exemplary steps that may occur between child and parent mobile devices and cloud platform 103:
1. Any data related to kid or parent may be stored in the “Local storage 105”.
2. Parent or kid information/data may be sent to the kid or parent respectively, from local storage 105 based on mapped Google Cloud Messaging (GCM)/Apple Push Notification Service (APNS) (GCM and APNS 101 layer) with a valued id.
3. The information which is in GCM/APNS may be received if mapped id valid.
4. The information in GCM/APNS may be stored cloud layer 103.
5. Kid or parent fetches the GCM/APNS data from cloud layer 103 using push messages.

The cloud platform 103 may also serve as a data backup for the mobile device. Additionally, the cloud platform 103 interacts or communicates with the APNS/GCM servers 101 to facilitate push messaging. The cloud platform 103 may be developed using J2EE and configured with frameworks, such as Spring and Hibernate. The data for an application may be stored in any database configured for use with the cloud platform 103 and may be encrypted. The cloud platform 103 may further use the HTTP protocol while communicating with the mobile device, APNS/GCM, and SMS gateways.

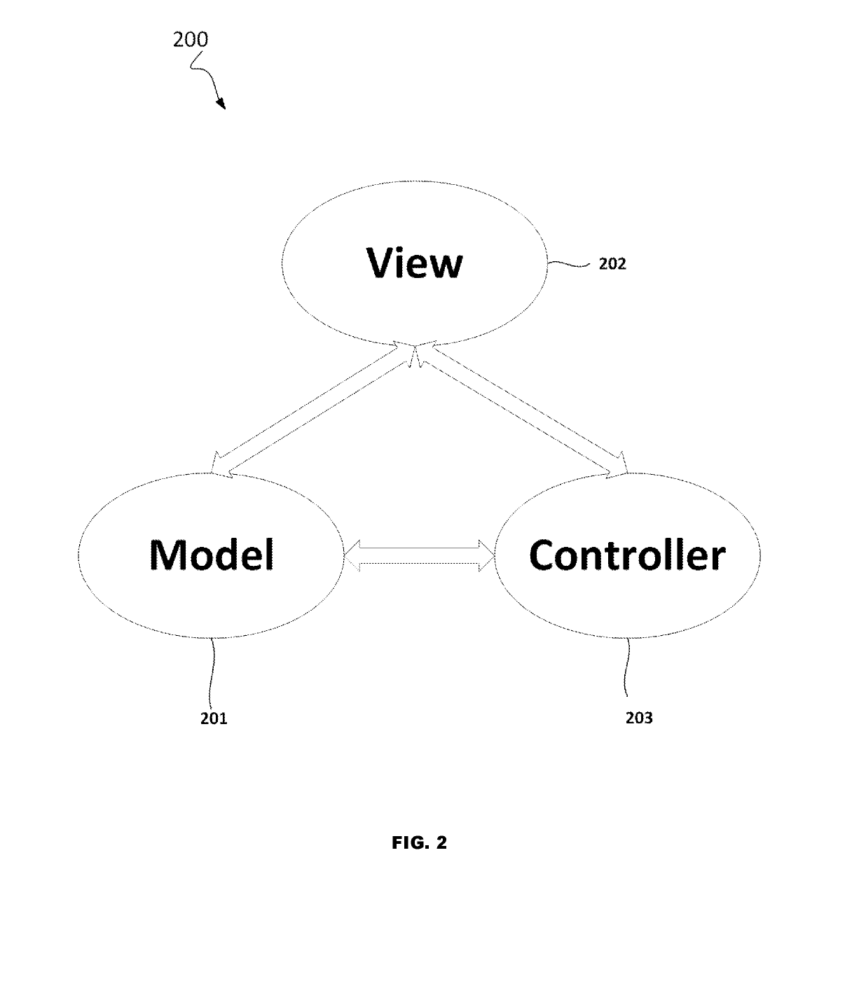

In some implementations, the system 100 may use a Model-View-controller (MVC) architecture pattern, as shown in FIG. 2.

The MVC architecture 200 may be used to separate the application into logical components and divide functionality among objects to minimize the degree of coupling between the objects. The MVC may include logical components: Model, View and Controller. In one embodiment, model may store data that is retrieved according to commands from the controller and displayed in the view. The view may generate an output presentation to the user based on changes in the model. The controller may send commands to the model to update the model's state. The controller may also send commands to its associated view to change the view's presentation of the Model

The model 201 represents the application data and the business rules that govern access and modification of the data. Business rules includes program logic which has been implemented in the application.

The model 201 may indicate to the view 202 when the model 201 changes and provides the ability for the view 202 to query the model 201 about its status. In one embodiment, the database helper and encryption engine classes store and execute the business logic.

DatabaseHelper and EncryptionEngine are two classes which are used in both parent and kid applications. Databasehelper class may be used to create a database and tables. EncryptionEngine class may include methods for encryption and decryption of application data.

In one embodiment, the view 202 renders the contents of a model 201. The view 202 accesses data from the model 201 and specifies how that data should be presented. In one embodiment, when the model changes, the view 202 may maintain consistency in its presentation.

In one embodiment, user interface (UI) classes may be responsible to maintain consistency and interact with one or more screens. In one embodiment, the UI classes may represent the view. In another embodiment, UI screens may interact with a database (DB) class for further functionality.

The controller 203 may be configured to define application behavior. In one embodiment, the controller 203 may be used to interpret user gestures and map them into actions to be performed by the model 201. Based on the user's gesture and the outcome of the model 201, the controller 203 may be used to select a view to be rendered as part of the response to a user request.

In one embodiment, a database accessor may map user action to the database, and thus may be the controller in MVC architecture 200. In one embodiment, MonQiAccessor is a class under a DB package. This class may include queries related to one or more tables. In one embodiment, using the methods under this class, data may be fetched or added and/or mapped on to the UI.

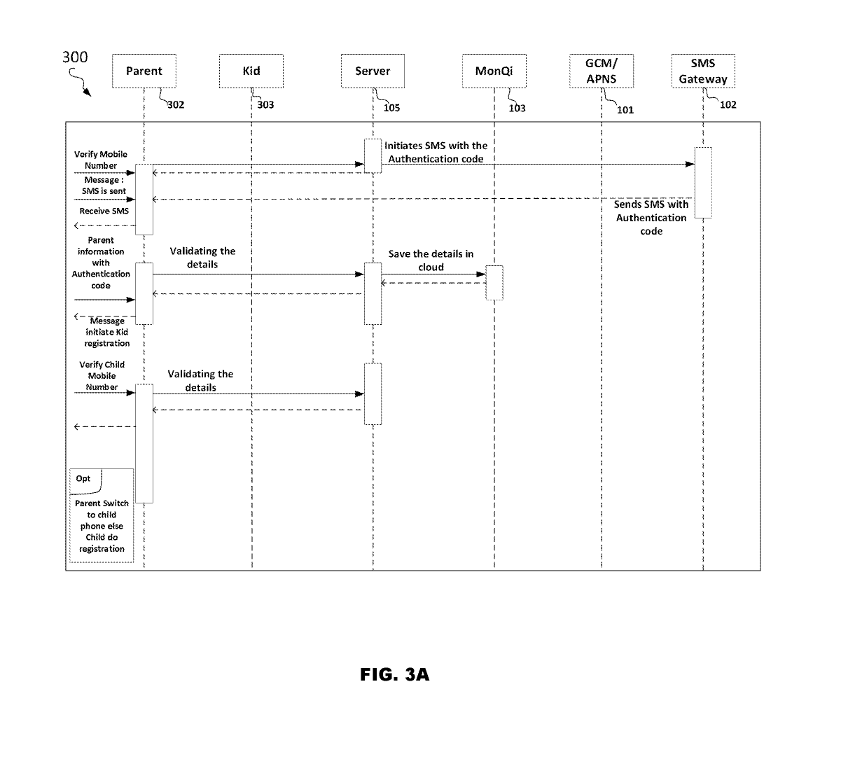

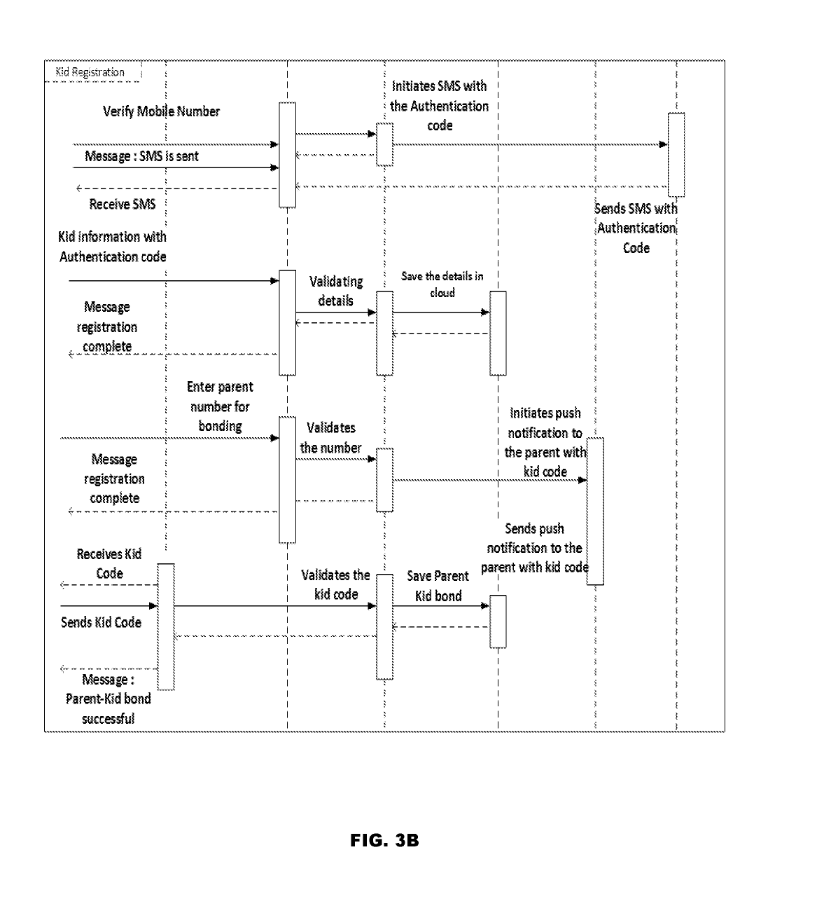

FIGS. 3A-3B illustrates a dataflow model for the parent-child registration of mobile devices and the communications between various components of the system 100, the parent device 302, the child device 303, and server 105. The solid lines show communication from component to the next and the horizontal dashed lines show a return communication between components in some cases. The slide bars on the vertical dashed and the accompanying text show the actions taken by various components. For example, as shown in FIG. 3A, the SMS gateway 102 sends the SMS authentication code.

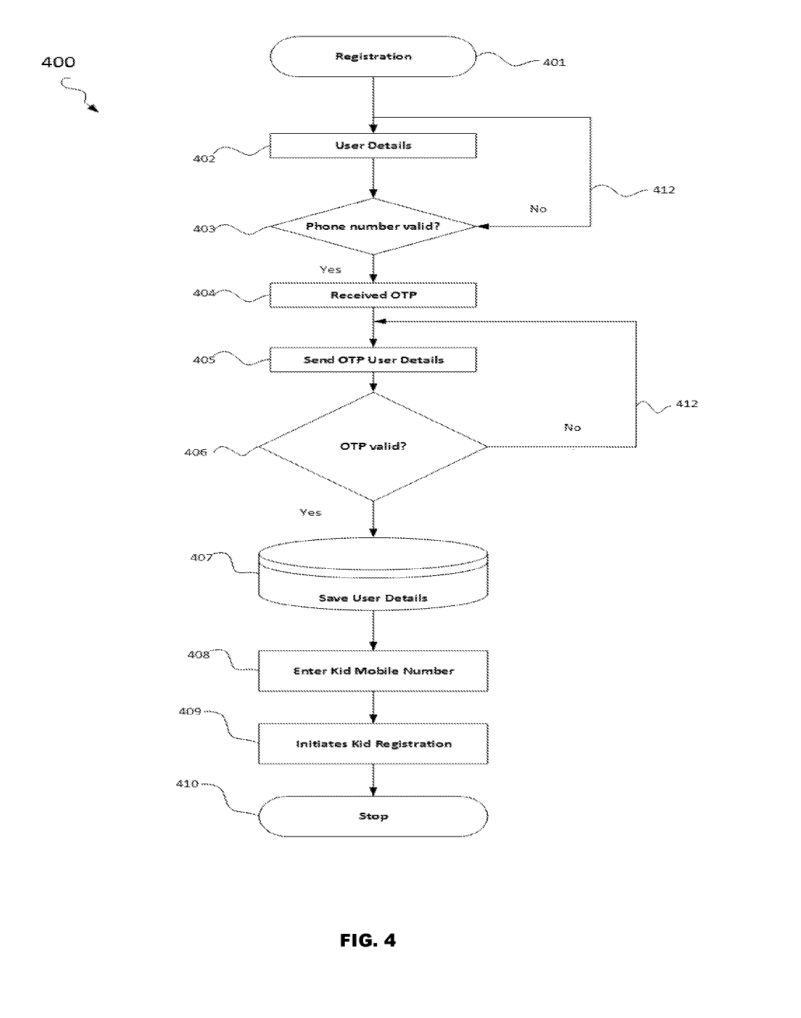

FIG. 4 shows the parents registration 400. As shown in FIG. 4, the parent begins the registration process at step 401. In step 402, the parent enters details associated with the parent, which may include name, phone number, email address, or other identification information. In step 403, the parent's phone number is validated by 404. If the number is not valid, then the process continues to step 412 and asks again for the number to be entered.

At step 404, a one-time passcode (OTP) is received at the mobile device of the parent via SMS text. The OTP may also be sent my email or other messaging protocols. At step 405, the code is entered and validated at step 406. If the code is not valid, the process proceeds to step 411 and another code is presented to the parent for entry. If the code is valid at step 406, the parent's details are saved and the child's phone number is entered at step 408, which initiates the child's registration at steps 409-410.

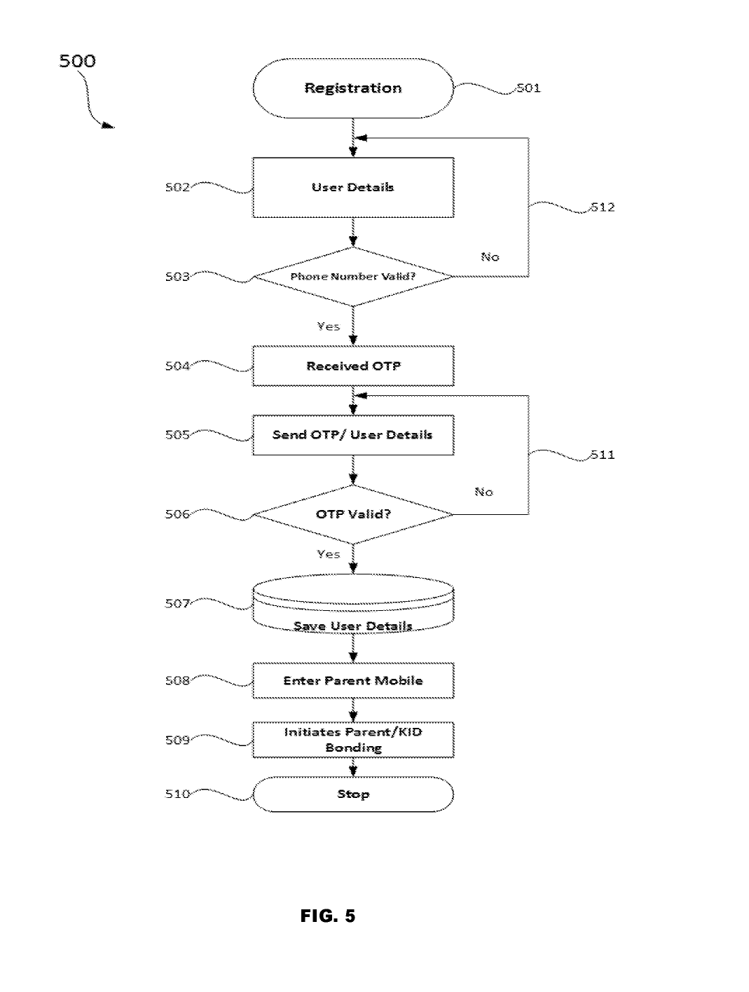

FIG. 5 shows the registration of the child's mobile device 500. In step 501, the registration process begins and the child's details are entered at 502. Steps 502-507 are substantially the same as steps 402-407, except the child's phone is used in FIG. 5. Additionally, steps 511-512 are substantially the same as steps 411-412.

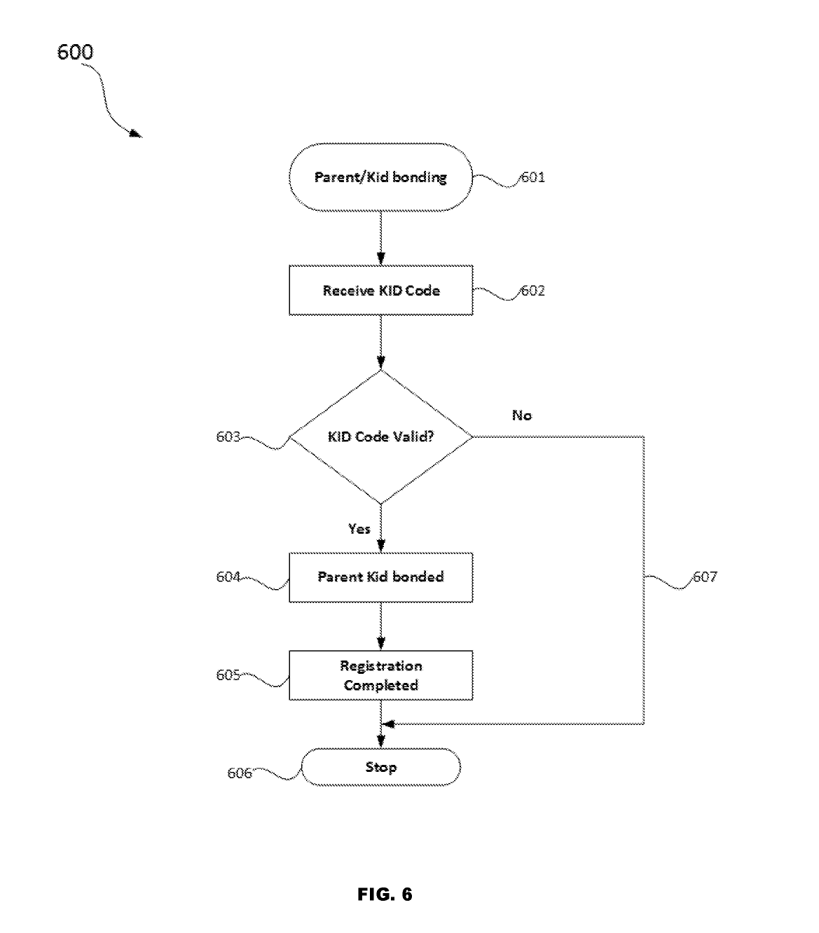

In step 508, the parent's mobile number is entered and at step 509-510, the parent-child mobile bonding occurs. FIG. 6 illustrates the parent-child bonding process 600. A code associated with the child is received at steps 601-602. The code is substantially the same as the OTP discussed in FIG. 4. At step 603, the code is verified. If the code is incorrect, the process proceeds to step 607 and again provides a new code. If the code is correct, the parent and child mobile devices are bonded at step 604 and registered at steps 605-606.

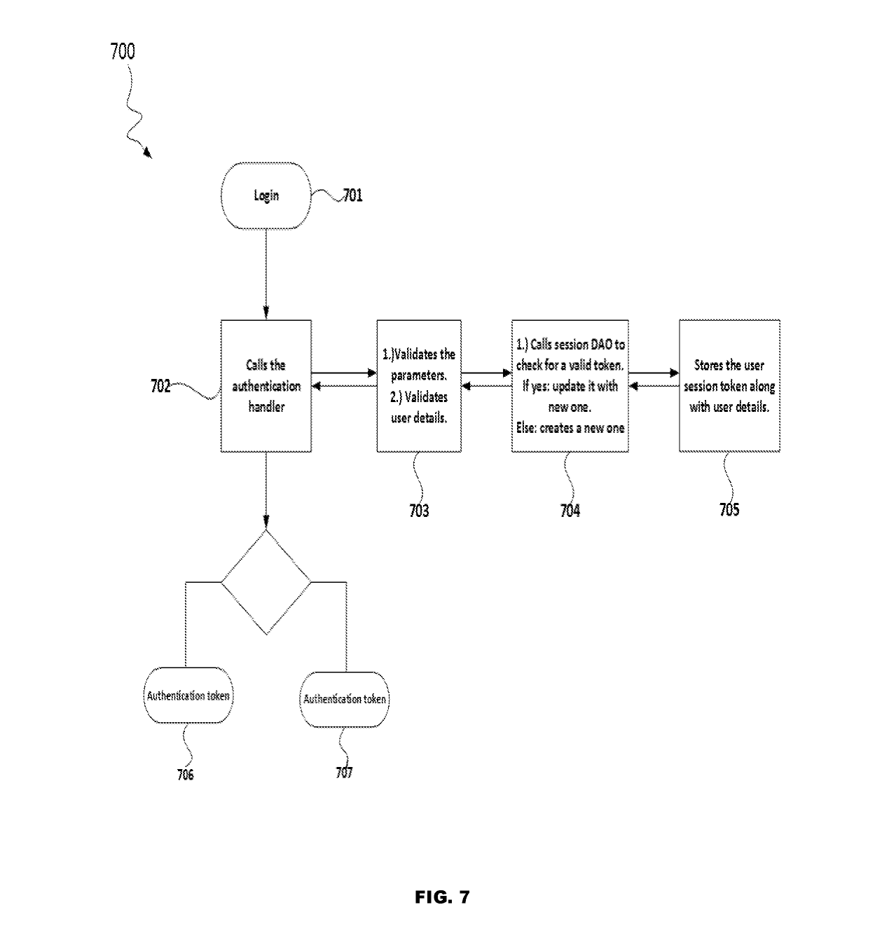

FIG. 7 illustrates the authentication module 700 in an embodiment. At step 701, a username and password from the user of the mobile device are retrieved. At step 702, an authentication handler is called. At step 703, the authentication handler verifies the username and password with the stored user information. At step 704, if the verification is successful, the control is moved to a session manager to create a new session token and saves the session information in a user session table at step 705. At step 706, the token is sent to a mobile device as a response, and at 707 exceptions that occur during this process are caught in the service class to send corresponding error messages.

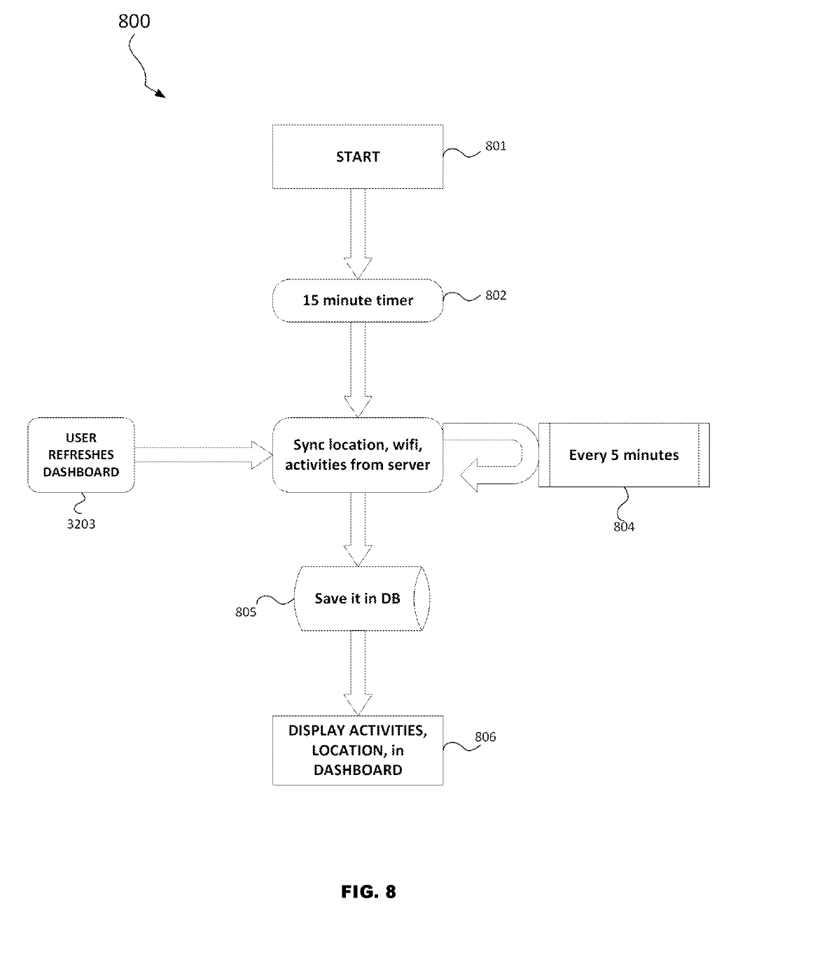

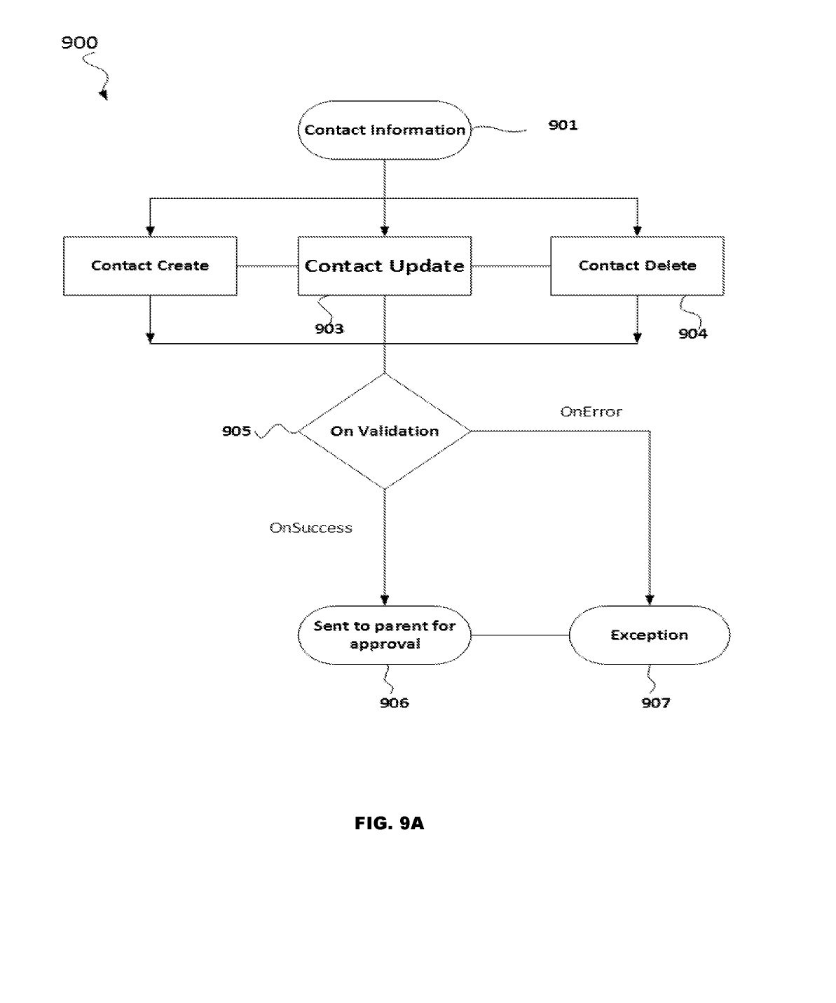

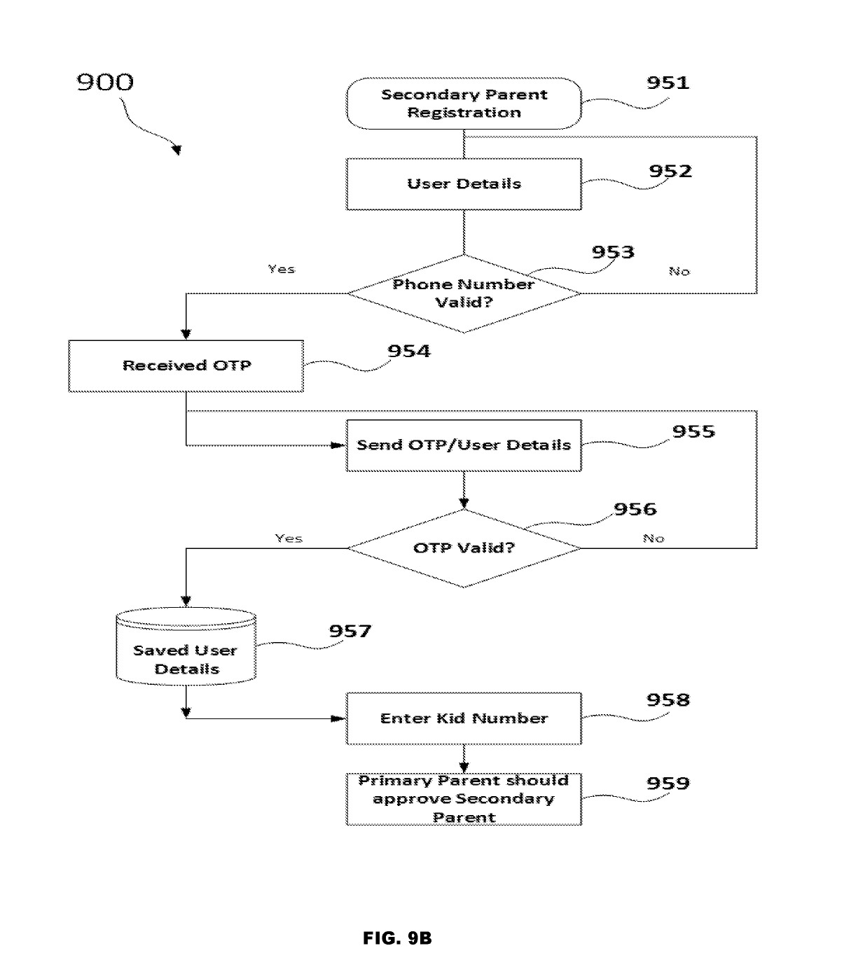

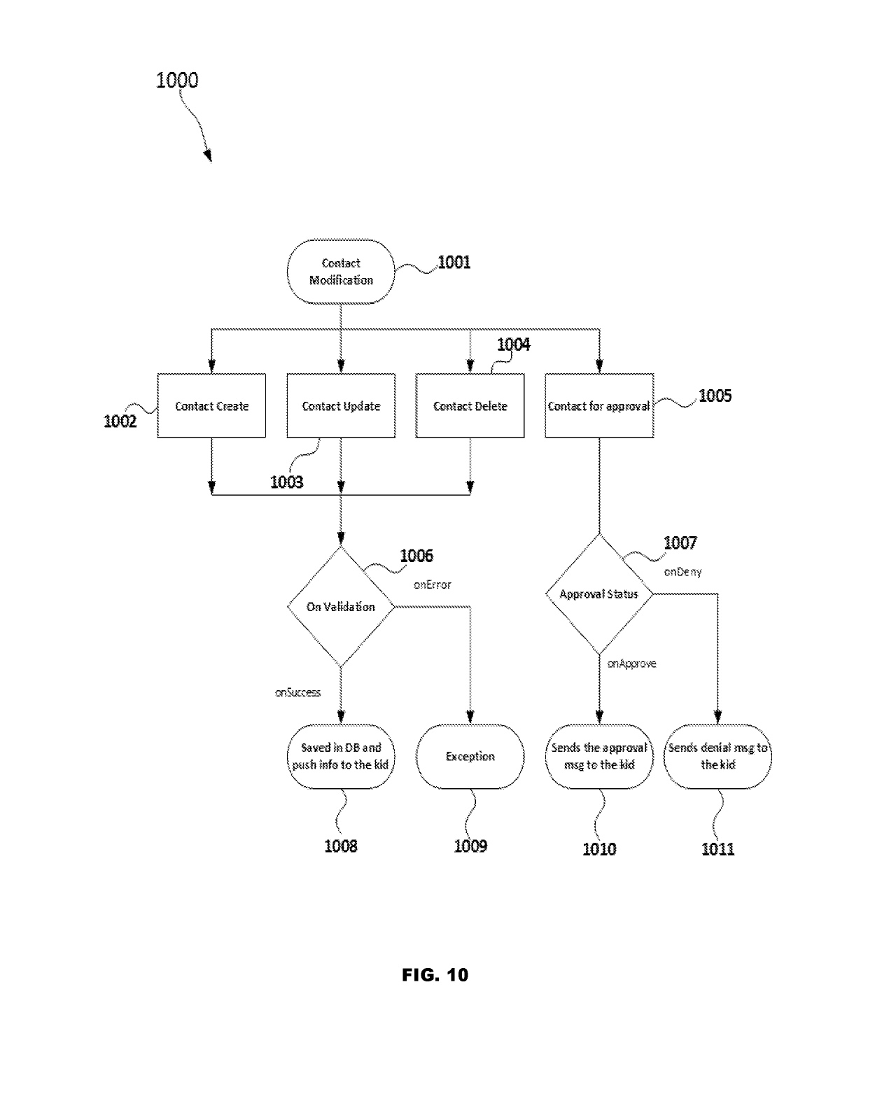

FIG. 8 shows dashboard updates in an embodiment. FIG. 9 shows the contact module for the child in an embodiment. FIG. 10 shows the contact module for a parent in an embodiment.

FIG. 8 shows dashboard updates 800 in an embodiment. The device is synched every 15 minutes from the application side at 801-802. The items to be synched may include wireless activity, location information, activities, application usage, and the like. The dashboard may be refreshed at 803-804. The synched information may be saved in the database at 805 and displayed in the dashboard at 806.

As shown in FIG. 9A, the contact module 900 may receive contact information at 901 from the child's application. A contact may be created at 902, updated at 903, or deleted at 904. On validation at 905, the contact may be presented to the parent at 906, if the validation was successful. If there is an error, an exception occurs at 907.

Referring again to FIG. 9B, a secondary parent registration 950 may begin at 951. At 952, user details are received by the application and the phone number of the mobile device verified at 953. Once a valid number is received, an OTP is received and validated at steps 954-956. The user details may be saved at 957 and child's mobile number may be entered at 958. The primary parent may approve the secondary parent at 959.

The contact module may operate in one example as follows. For modifications to the contacts from the child's mobile device, contact information may be retrieved from the child's application, which calls the “modifyContactByKid” method in the service class. The service class may call the corresponding handler method to verify the requester's information and to validate the request data. In one embodiment, the requester's information and request data is from the child application. The data may then be stored in a temporary table using manager and DAO classes. A GCM/APNS push notification may be sent to the parent and a response may be sent to the child.

In one embodiment, the parent application may access a list of pending requests by calling “getApprovalList” web service. The parent may either accept the request or deny the request. Parent approval status along with contact information is pushed to the server. The handler class validates and verifies the request, removes the data from the temporary table and saves the update in the contact table. The update or modification is sent to the parent and child.

For server side operation of contact modification by the parent, the parent pushes the contact details to the server with a default approval status set to approved. The handler class validates and verifies the request and saves the update in the contact table. The modification is sent to both parent and child.

For the application side operation of the contact module for the child, the contact information is sent for approval via the server to the parent. The server may verify the requester's information and to validate the request data. Once the verification is validated, a GCM/APNS push notification is sent to the parent and a response is sent to the child of the decision by the parent.

In one embodiment, a parent may access a list on pending requests by calling “getApprovalList” web service. In one embodiment, the parent may either accept the request or deny the request. The parent approval status along with contact information is pushed to the server. The server may validate and verify the request and save the update in the contact table. The modification is sent to both parent and child. If the parent approves the contact, the contact may be added into contact list.

For the application side operation for the parent, the parent pushes the contact details to the server with a default approval status set to approved. The handler class validates and verifies the request and saves the update in the contact table. The modification is sent to both parent and child.

FIG. 10 shows the parent-side contact module 1000. At step 1001, a contact modification is processed to create at 1002, update at 1003, or delete at 1004. If the contact is validated at 1005, then the details are saved in a database and the details of the contact are pushed to the child application at 1008. If there is an error, an exception occurs at 1009. If at 1005, a contact is approved, an approval status is determined at 1007. If approved, then an approval message is sent to the child at 1010. If the request is denied, the denial is sent to the child at 1011.

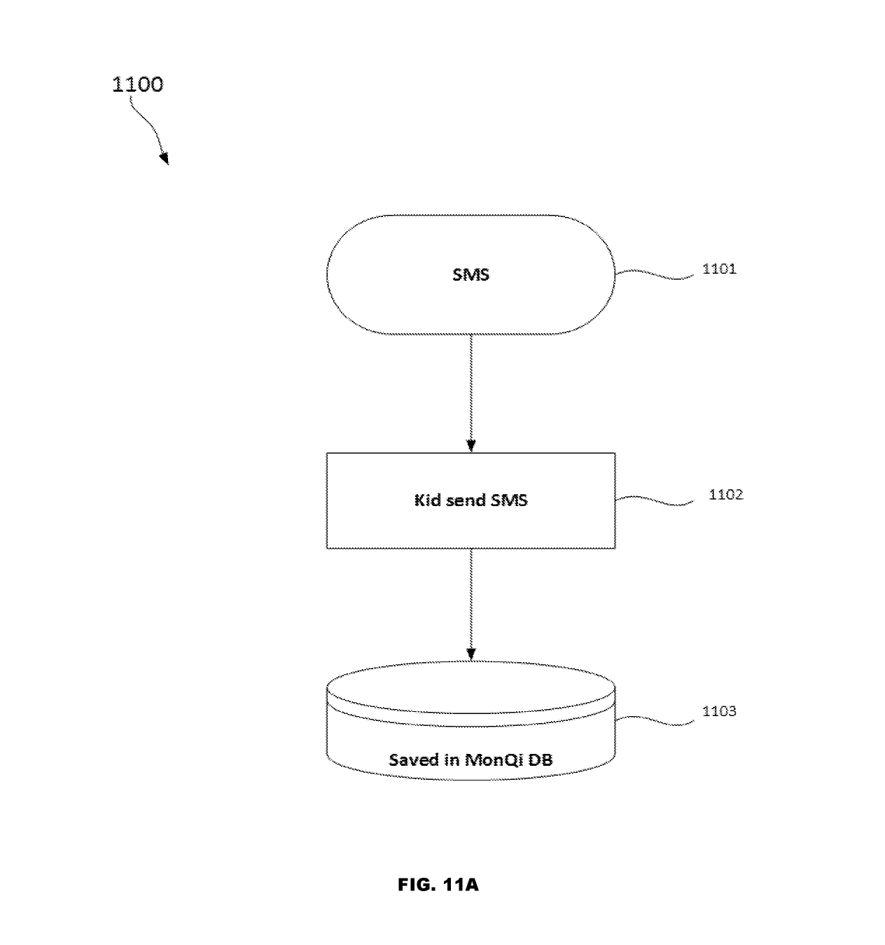

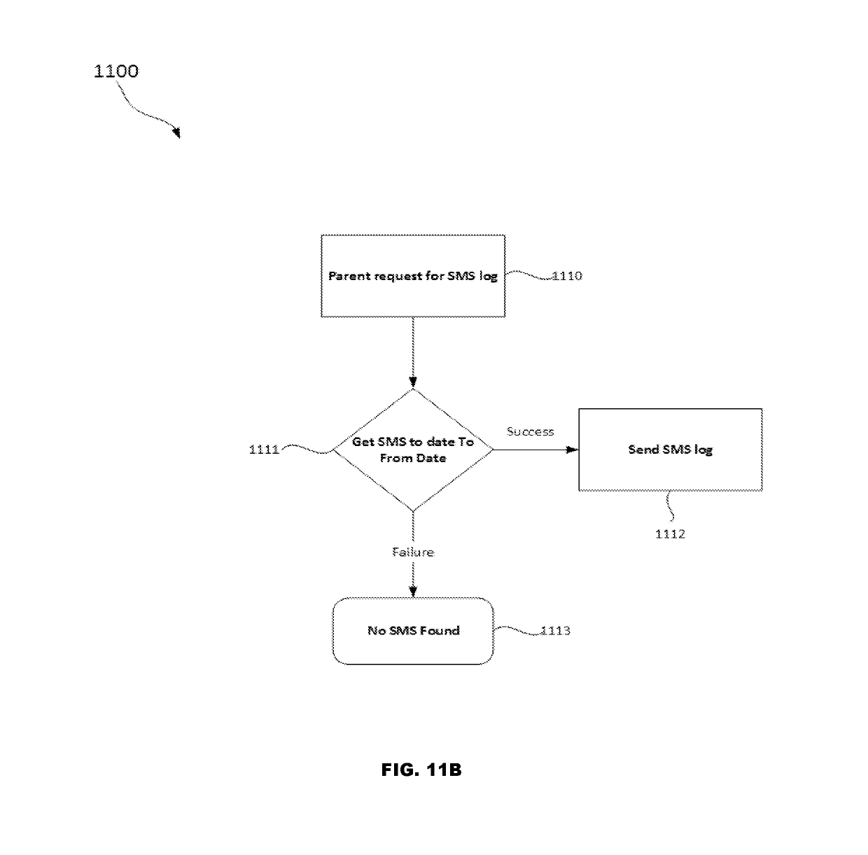

FIGS. 11A and 11B describe the SMS module. In FIG. 11A, if the child sends a SMS message in step 1101-1102, the SMS may be stored in the cloud platform 103. If the parent would like to view the SMS messages sent by the child, a log is requested in step 1110 and the SMS messages are requested from the system 100 in step 1111. If there are messages, they are provided to the parent at step 1112 or no messages are provided at step 1113.

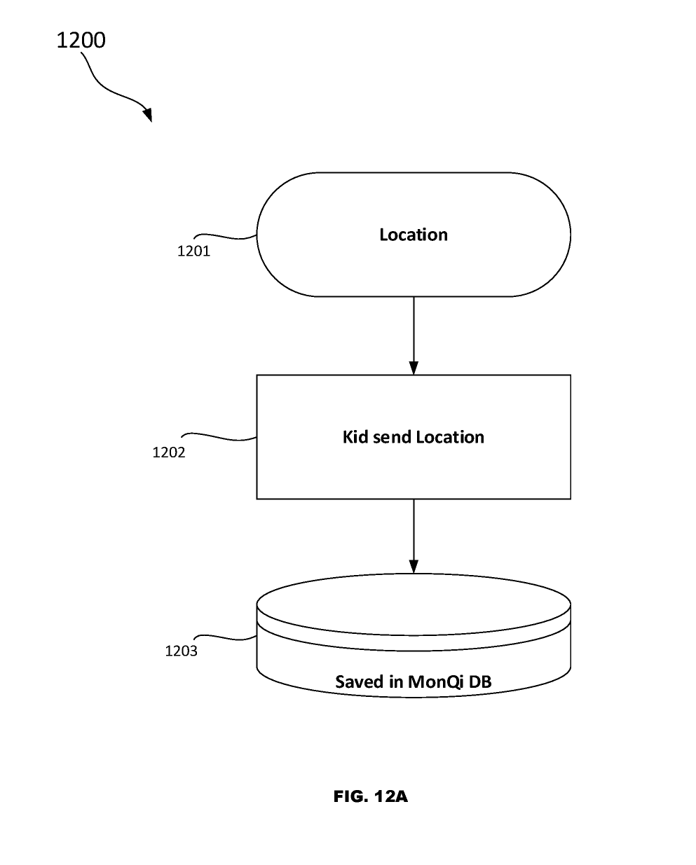

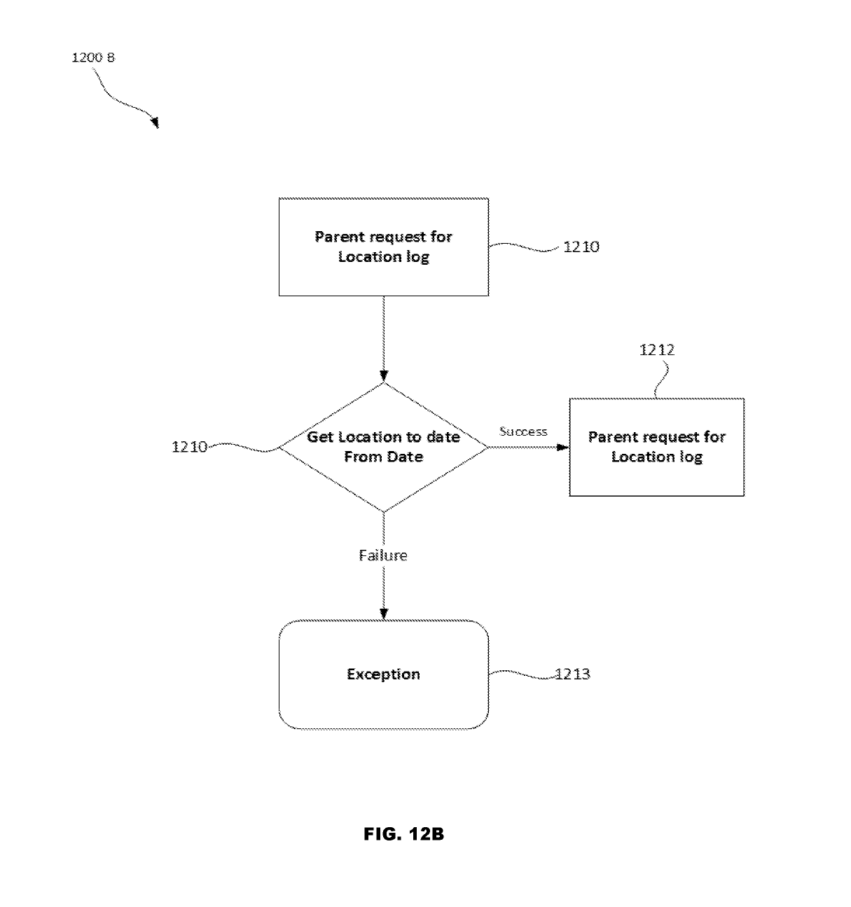

The system may also include a location module that allows the parent to track the whereabouts of the child via the mobile device. In one embodiment, GPS may be used. In another embodiment, the child may be prevented from altering the GPS options on the child's mobile device. As shown in FIG. 12A, the location of the child may be tracked at step 1201. The location may be sent and saved at steps 1202-1203. In FIG. 12B, the parent may request the location of the child at steps 1210 and 1211. At step 1212, a successful request may return location results. At step 1213, an exception may be sent if the location is not available.

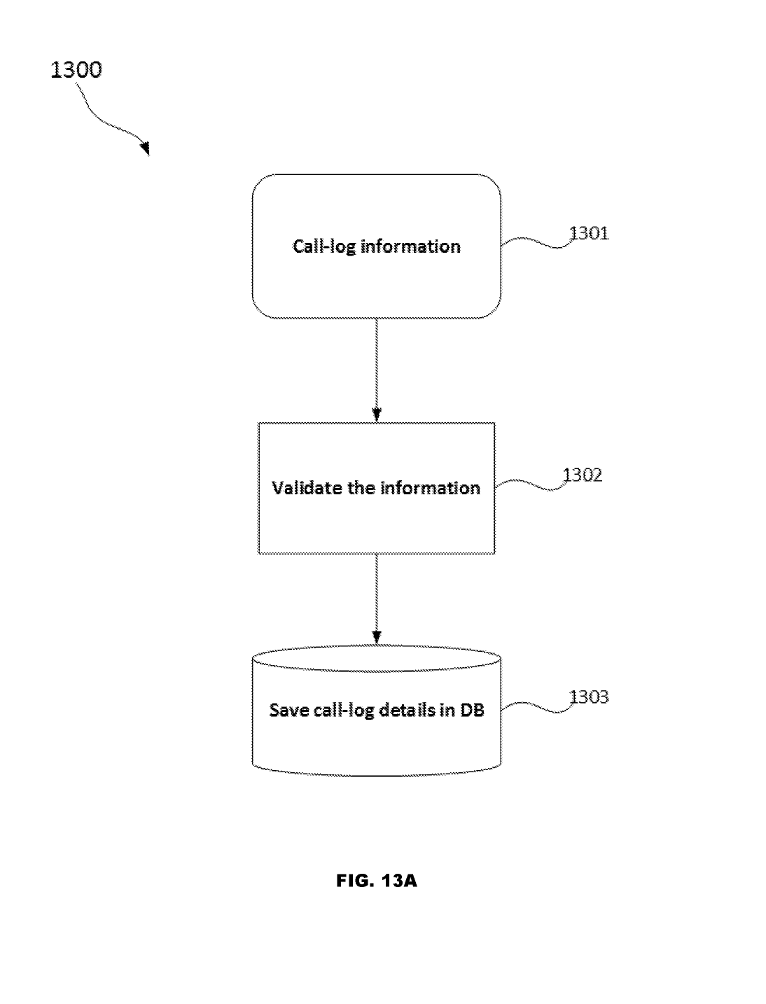

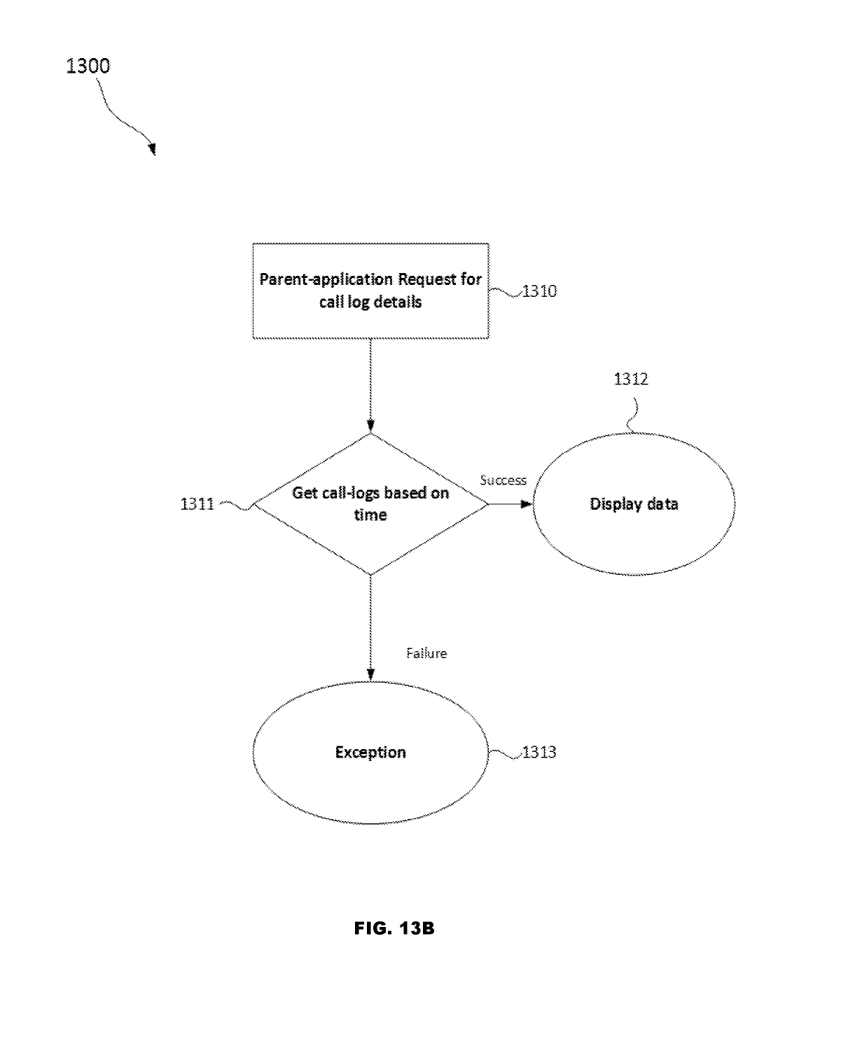

The system may also include a call-log module. As shown in FIG. 13A, at step 1301, call log information of the child may be tracked. At step 1302, validation involves fetching the call logs and verifying whether the fetched number exists in the DB, measuring the time, history of call made and received and finally storing in the DB.

At step 1303, the call log information is stored. As shown in FIG. 13B, the parent may request the call log information at step 1310-1311. In one embodiment, the log may be requested based on the time of the calls made by the child. The call log information may be successfully transmitted at step 1312 or an exception occurs at step 1313.

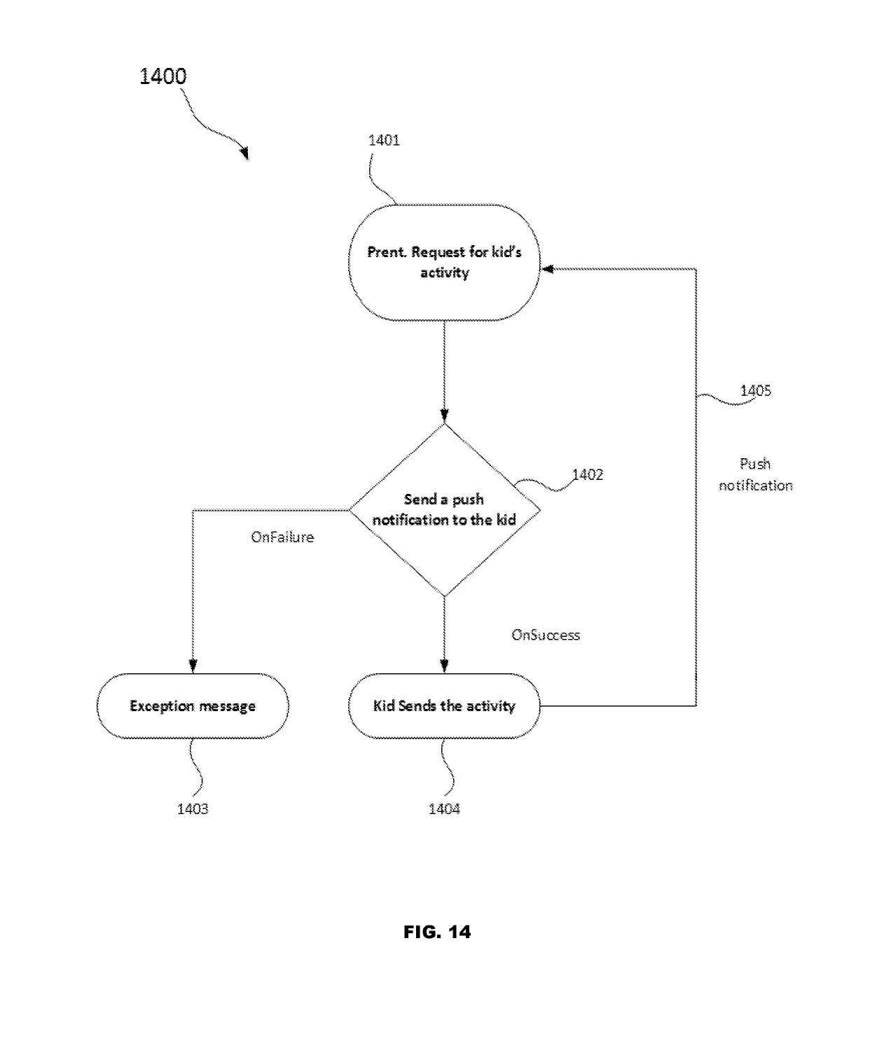

The system may also include an activity module, as shown in FIG. 14. In one embodiment, the parent requests a status from the child in step 1401. A push notification of the request is sent at 1402. If successfully received, then the child sends a response at step 1404 and the response is pushed to the parent at step 1405. If the request is not received, an exception occurs at step 1403.

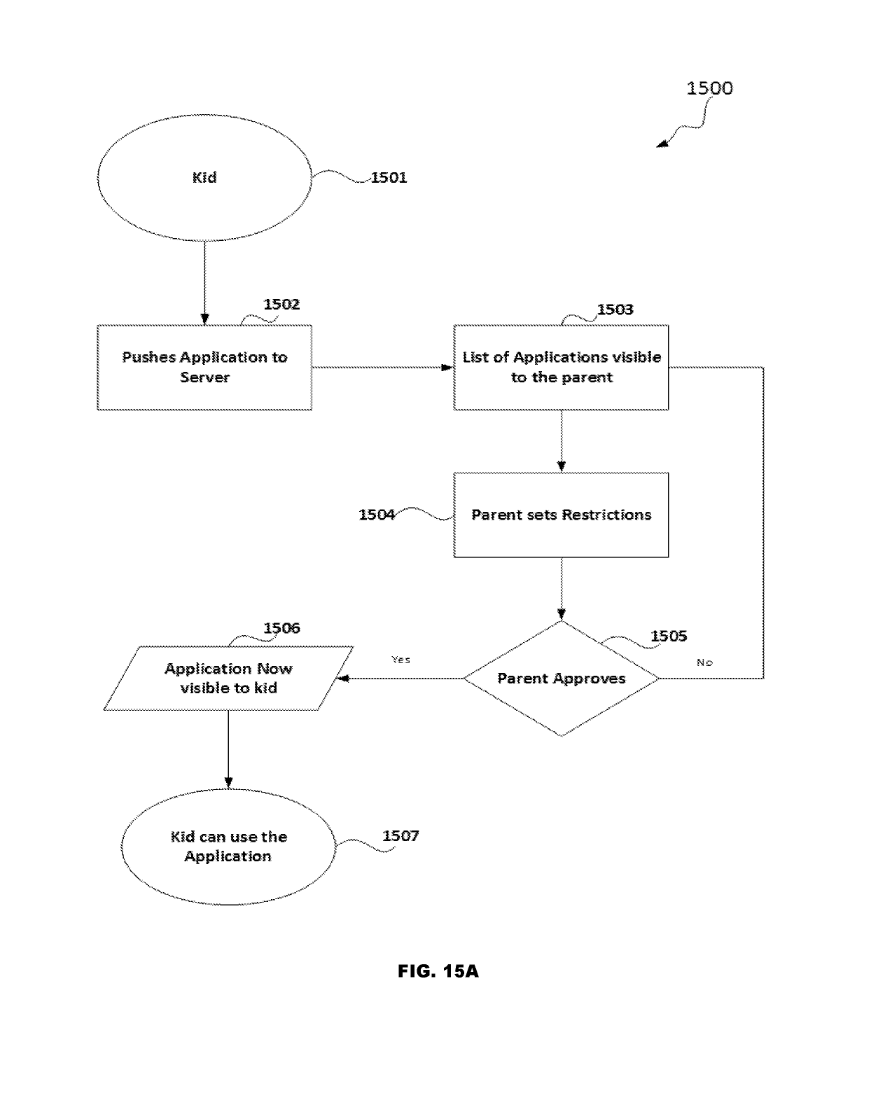

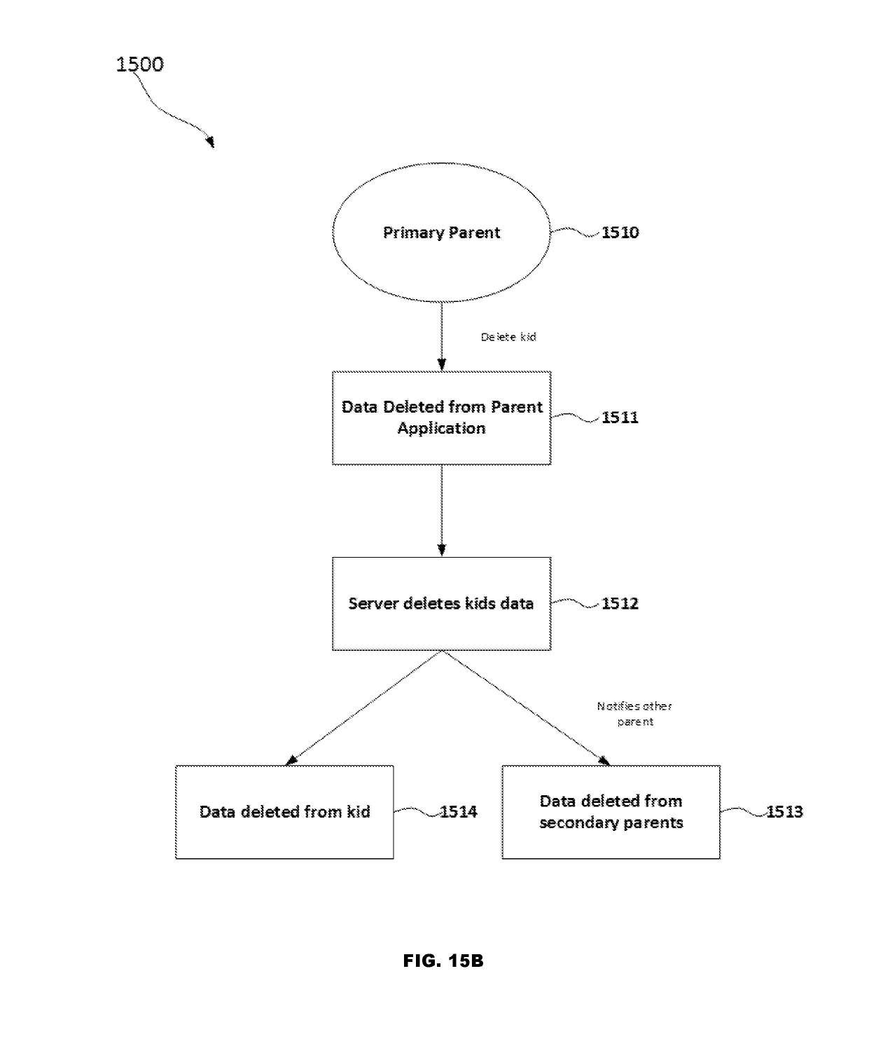

FIGS. 15A-15B show the applications module in an embodiment. In one embodiment, applications in the kid phone may be synced to the server and a notification may be send to one or more parents. The parent application then gets the application list from the server. The primary parent has the option to control the application usage, such as application visibility, time limit, etc. A secondary parent can view the restrictions that was set by the primary parent. It should be noted that an application is software that is executed on a mobile device. As shown at 1500, the kid provides an application to a server at 1502 and a list is provided to the parent at 1503. A parent may set restrictions at 1504 and a parent may be approved at 1505. If approved, the application may be viewed at 1506 and used at 1507.

As shown in FIG. 15B, the primary parent at 1510 may delete the bonded kid's device at 1511 and the server will delete and reset the kid's device from the database and then deleted from the child's phone at 1514 and the secondary parent phone at 1515.

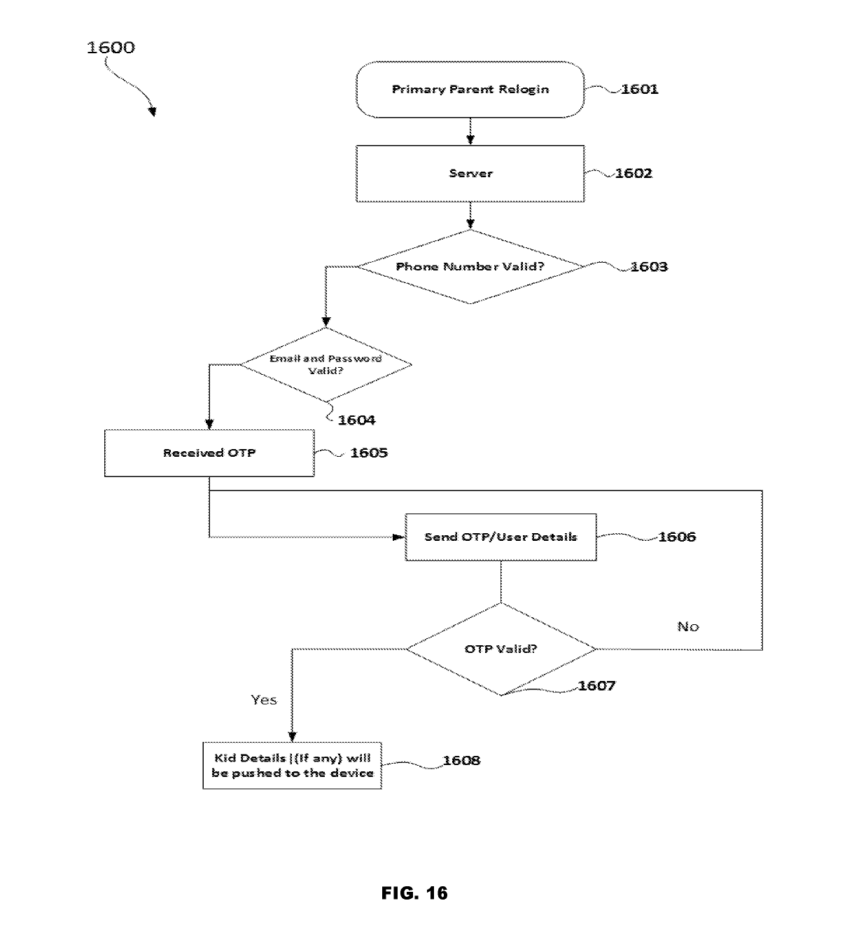

FIG. 16 shows a flow for a parent to re-login at 1600 and 1601. At 1602-1604, the parent enters the number, email, and password associated with the parent. Assuming the information received is valid, the OTP will be issued and validated at 1605-07. The details of the child may be pushed at 1608.

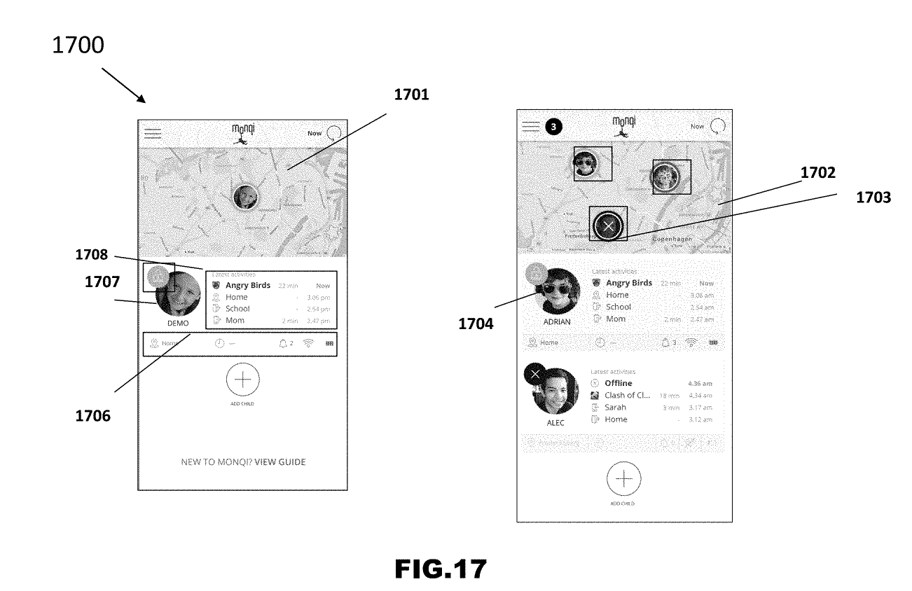

FIG. 17 shows an example of parent mobile device 1700. The device 1700 may include a dashboard 1701 or other user interface 1702. An information bar may be included that shows current geo-location zone, an active schedule, notifications, and wireless/data access. A quick lock may be shown at 1707 indicating whether the child's phone has been locked or unlocked by the parent. A display 1708 may show the latest activities of the child including the applications accessed (timing and duration), geo-zone entry and departure (timing), and calls (timing and duration). A user interface 1702 may include photos of one or more kids 1704 and any associated details about the child and his or her activity. The mobile device 1700 may also include a memory, processor for execution the parent application, the ability to connect wirelessly to one or more networks, a speaker, and other features typically found in a mobile device, such as an Apple IPhone or Samsung Galaxy.

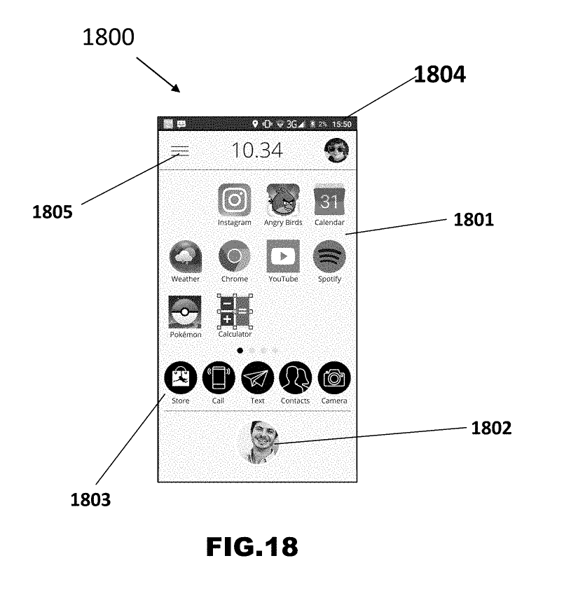

FIG. 18 shows a child mobile device 1800 with a user interface 1801 with a quick access tab to the parent 1802, access to the app store 1803, a menu to customized settings 1805, and a notification status bar that is locked from sliding to reveal the settings 1804. The mobile device 1800 may also include a memory, processor for execution the child application, the ability to connect wirelessly to one or more networks, a speaker, and other features typically found in a mobile device, such as an Apple IPhone or Samsung Galaxy.

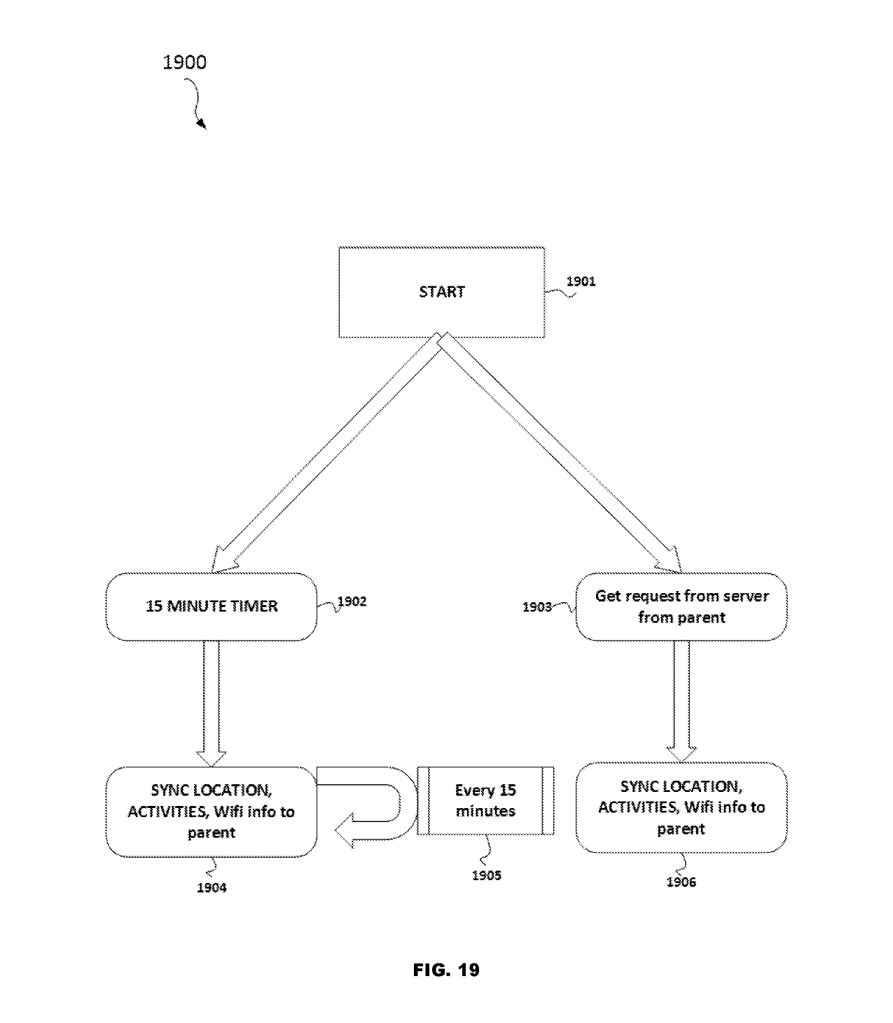

FIG. 19 shows updating a parent dashboard 1901 from the child device in an embodiment. In one example, the kid app syncs the information such as battery, Wi-Fi, apps, and timestamps to the server every 15 minutes immediately after bonding, as shown in steps 1902-1906. The parent may receive the GCM or APNS after synching to the child device. Upon receiving the GCM/APNS, the parent may call get-Kid-dashboard routine to get the dashboard details of the kid. In other examples, the parent can also do a manual refresh on the kid for the details. The parent calls the sync-kid-dashboard on the kid application. This sends the GCM/APNS to update-kid-dashboard to the server for synching. This again triggers the GCM/APNS to the parent after which the parent calls the get-Kid-dashboard. Dashboard details of the kid may be stored in the database in the parent application.

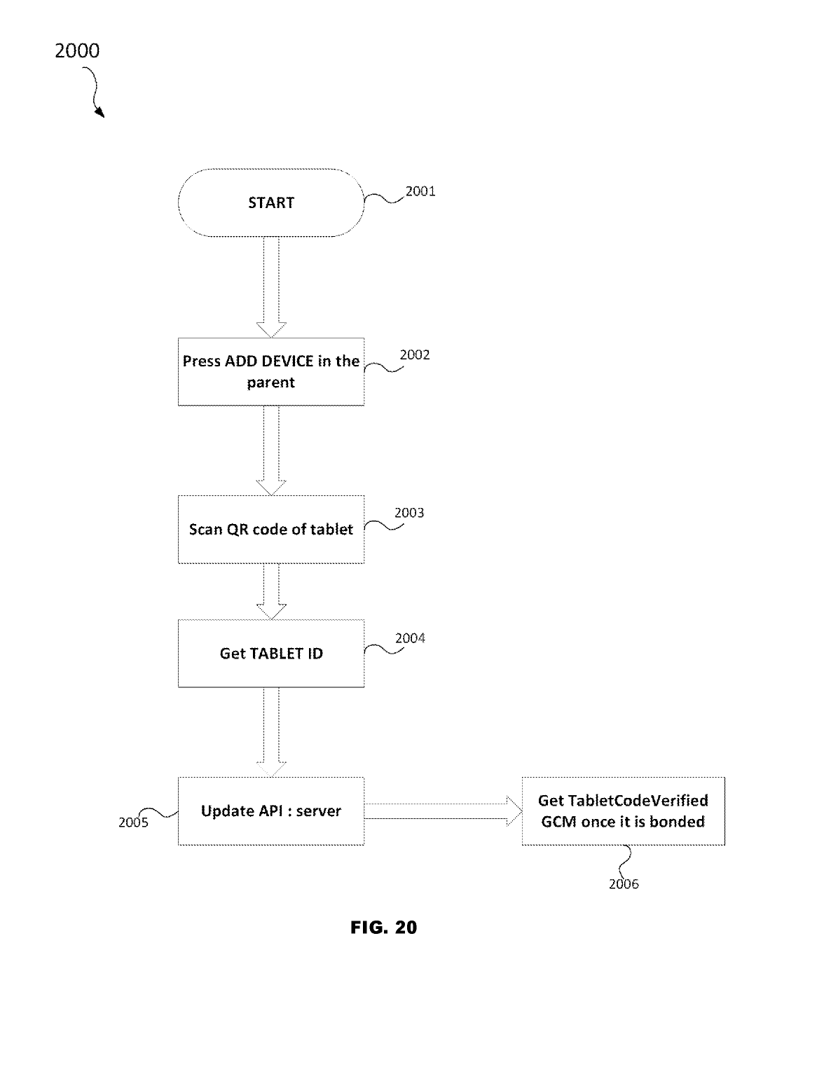

FIG. 20 shows a flow for adding another child device to the parent application 2001 in an embodiment. At 2002, the process may be initiated to add a device. The device may be a tablet, a mobile device, desktop computer and the like. A code or other identifier of the device may be obtained at 2003 and 2004. At 2005, the database or server may be updated and the device may be verified when it is bonded to the child or parent device.

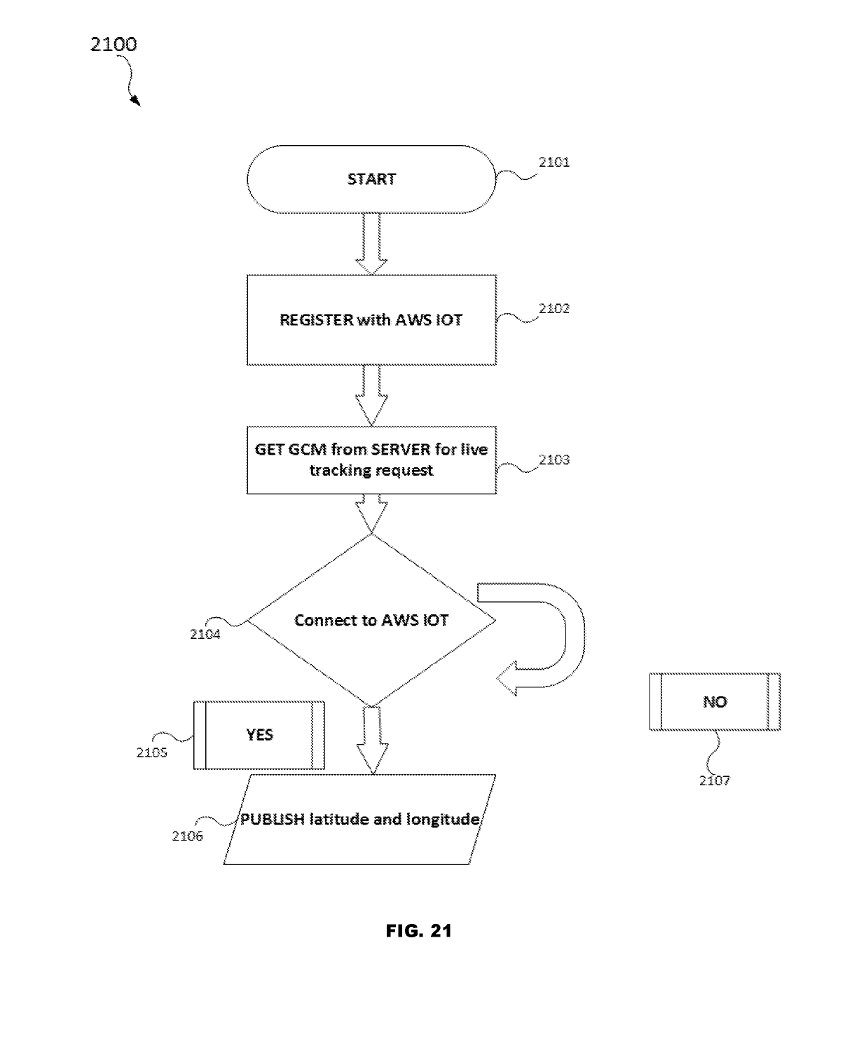

FIG. 21 shows live tracking for the child device 2100 in an embodiment. At 2101-2102, the child device registers and the GCM is received at 2103 for a live tracking request. At 2104, if the device is connected at 2105, the latitude and longitude may be published. If not at 2107, the process tries to reconnect.

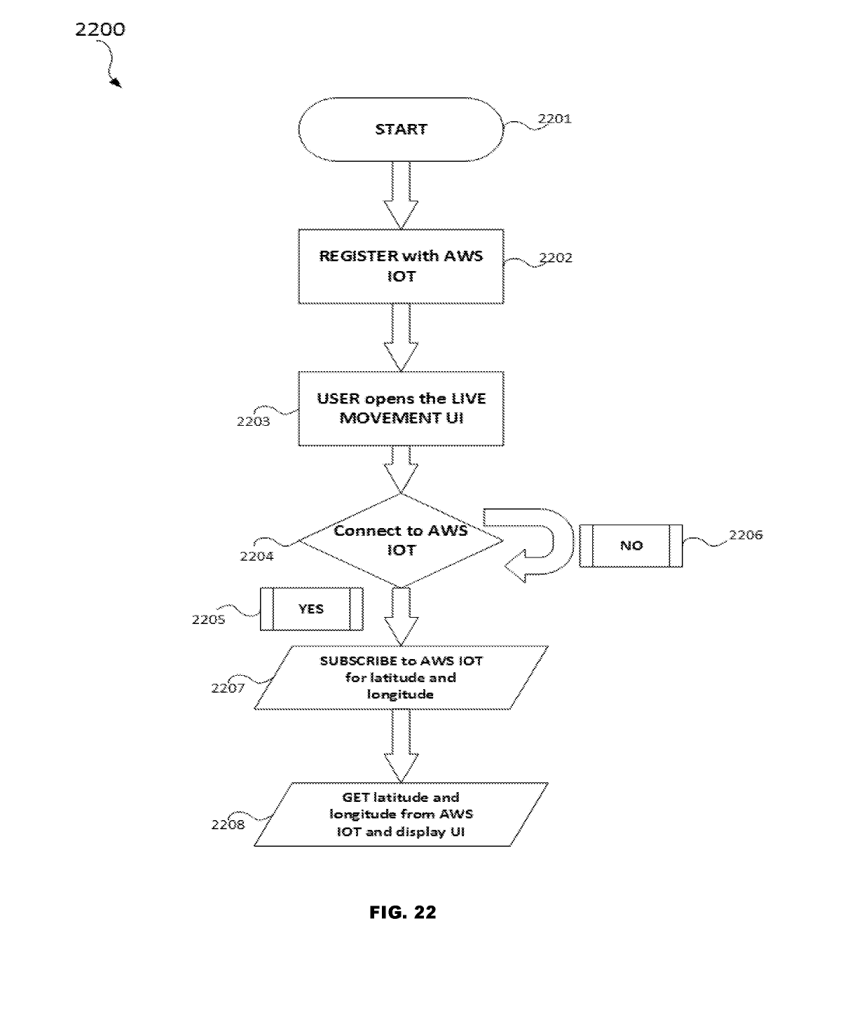

FIG. 22 shows live tracking for the parent device 2200 in an embodiment. At 2201-2202, the device is registered. At 2203, a user interface may be opened to track live movement. The device may be connected at 2204 and if the connection fails at 2206, the process reverts back to 2204. If connected at 2205, the latitude and longitude may be fetched at 2207-2208.

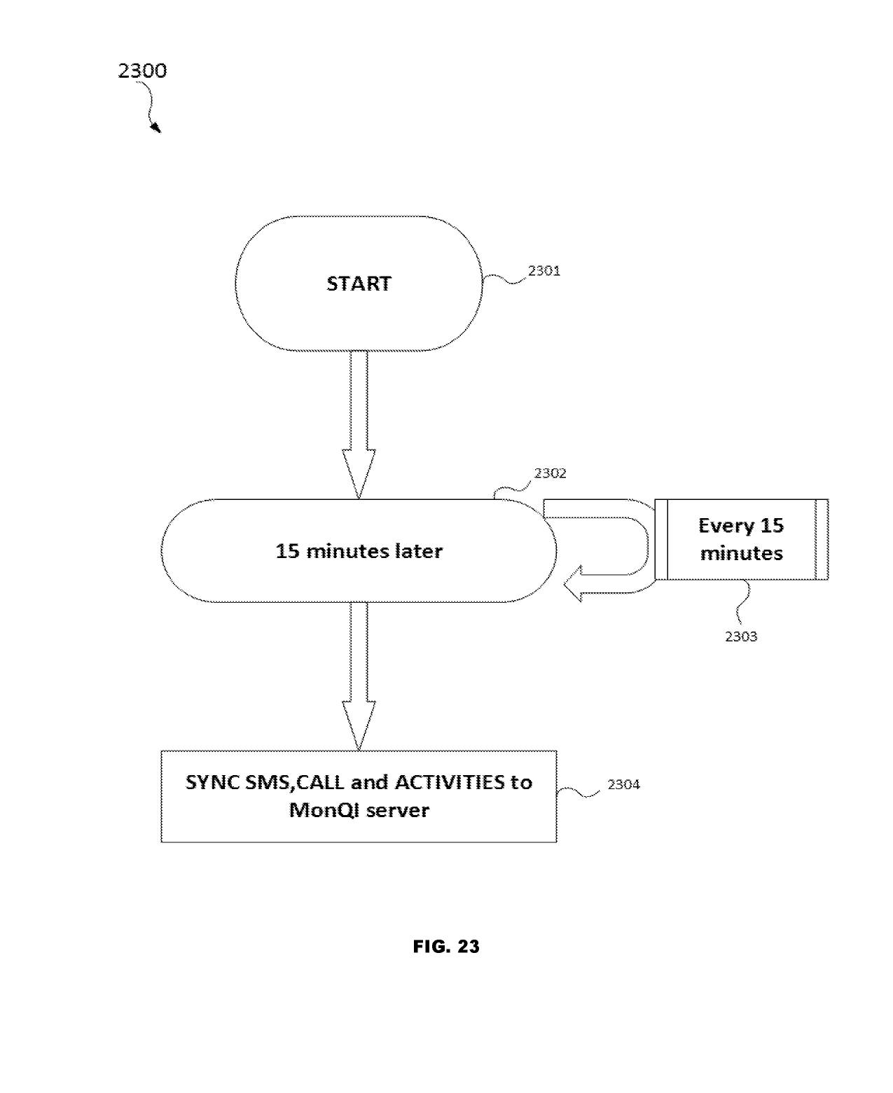

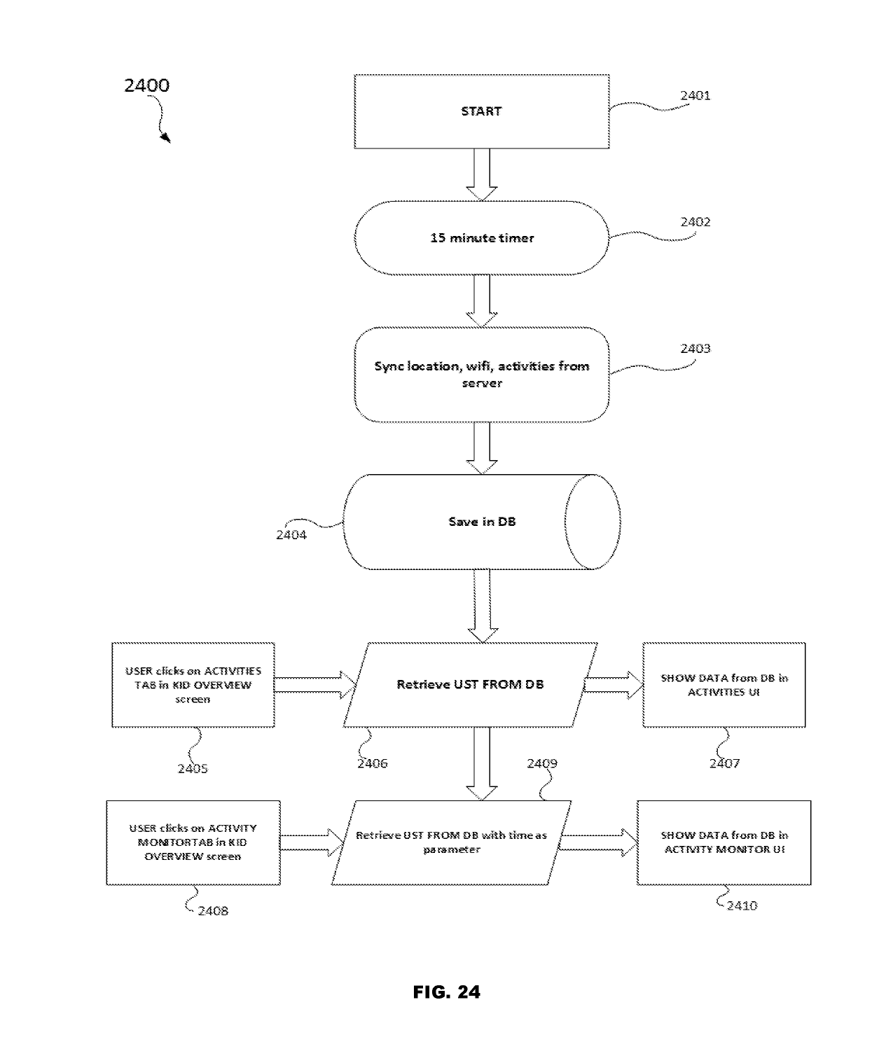

FIGS. 23-24 show an activity monitor for a child device updating activity. As shown in FIG. 23 at 2300-2302, the child device syncs the call logs, SMS logs and activity information to the server every 15 minutes. At FIG. 24, the data is synched at 2401-2403 and stored in a database at 2404. From 2405-2407, the parent may click on an activities tab on the mobile device and view the updated activities of the child in one view. At 2408-2410, the parent device may also use the activity monitor to view the activities in another view of the child.

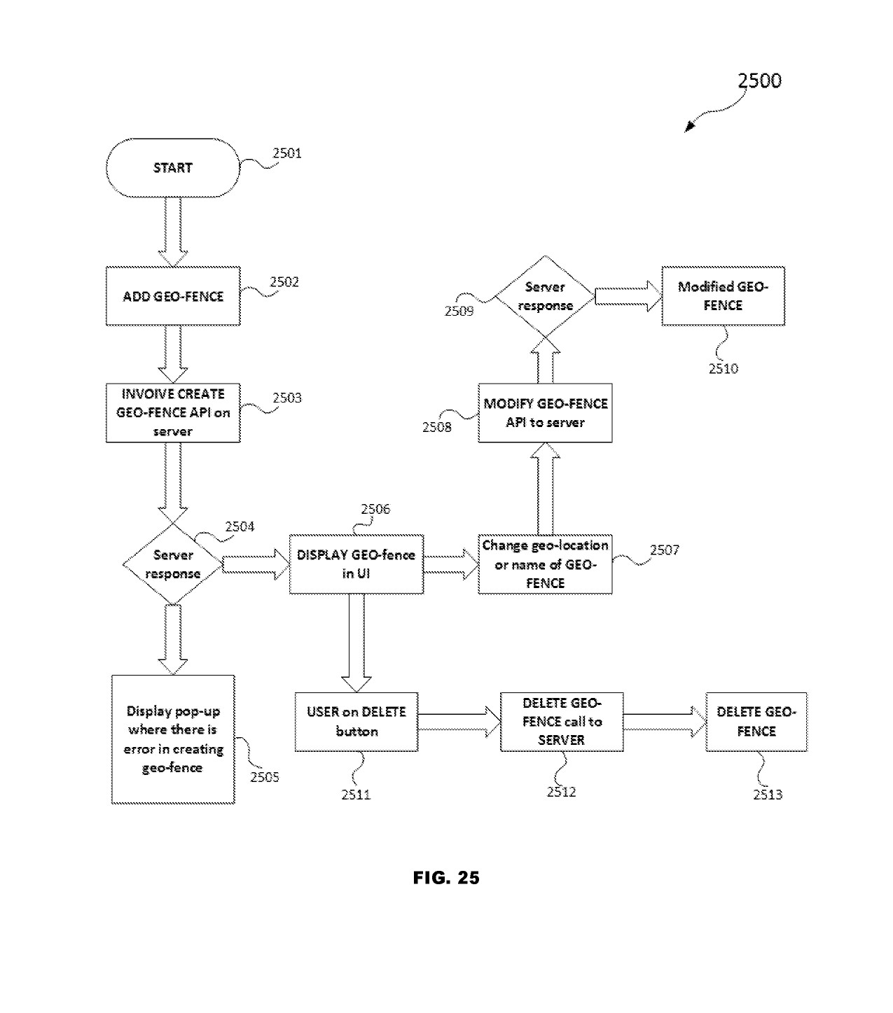

FIG. 25 shows geo-fencing 2500 in an embodiment. At 2501-2502, a geo-fence is created at 2503 and at the server 2504. The geo-fence may be displayed at 2506 so long as there is no error at 2505. The geo-fence may include zone name, zone status, entry status and/or exit status. The geo-fence may be deleted, as shown at 2511-2513. The geo-fence may be modified by the parent device, as shown at 2507-2510.

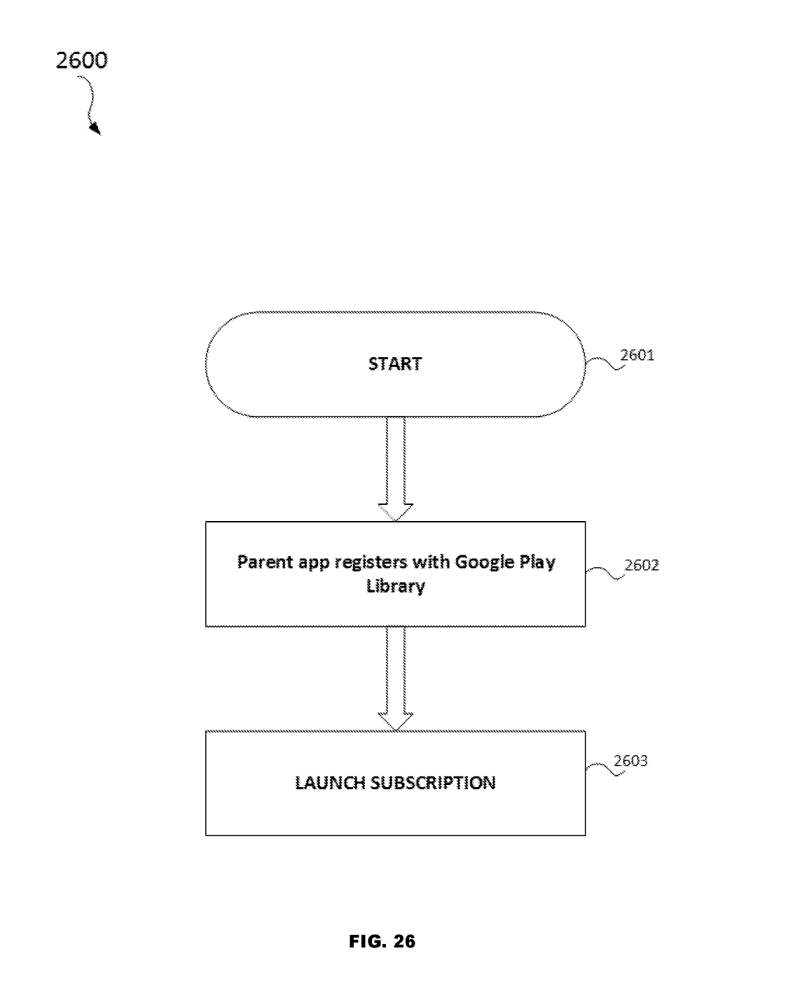

FIG. 26 shows In App purchases 2600 in an embodiment. The parent application may register and purchase and launch a subscription for one or more premium parent services, as shown at 2601-2603.

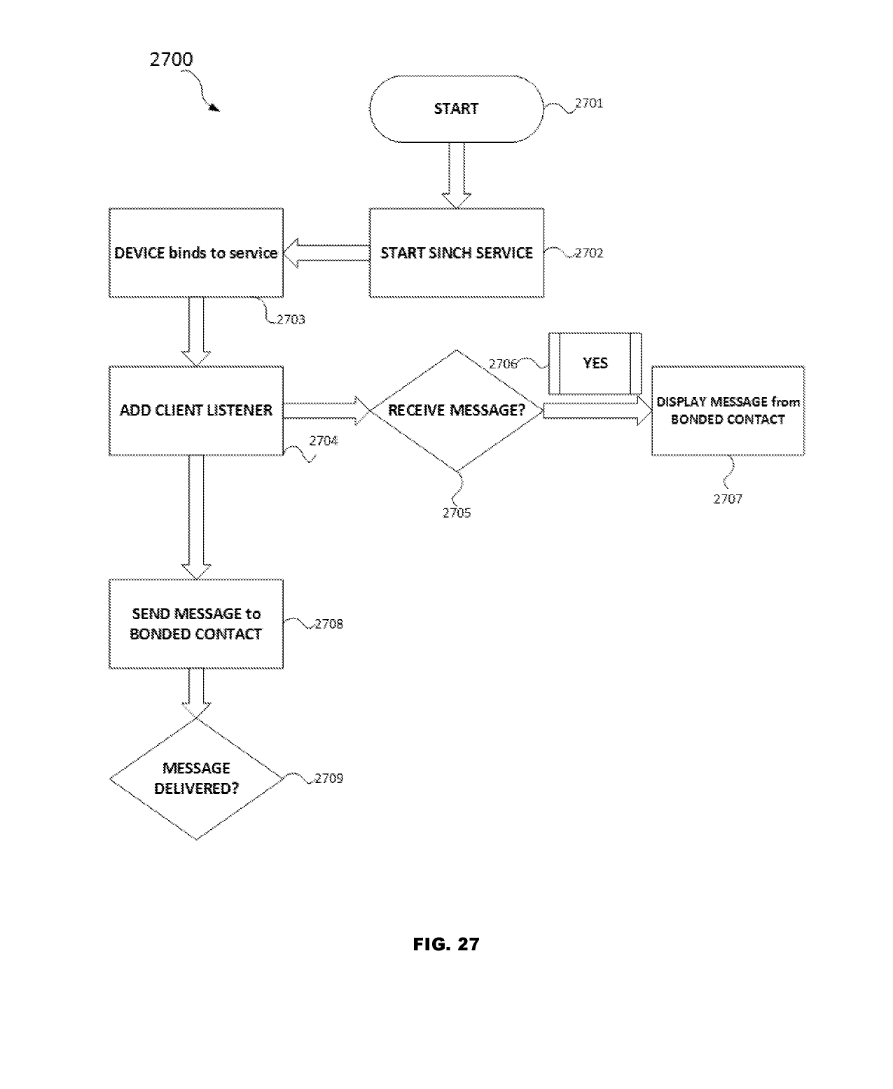

FIG. 27 shows Parent-Child messaging using Sinch service in an embodiment. Sinch which allows for instant messaging functionality. At 2701-2703, Sinch is started and a device binds to the service. A client listener is added at 2704, a message is received at 2705-2706 and a message from a bonded contact is displayed at 2707. A message may be sent to a bonded contact at 2708 and delivery may be confirmed at 2709.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A computer-implemented method for controlling a second mobile device from a first mobile device, comprising receiving by a processor of the first mobile device a request to approve a contact transmitted by the second mobile device, approving by the processor of the first computing device the contact by pushing the approval to a processor of the second computing device; monitoring by the processor of the first mobile device an amount of time that the contact is in communication with the second mobile device; and adding a second contact by the processor of the first mobile device directly to the second mobile device from the first mobile device.

2. The method of claim 1 further comprising requesting by the processor of the first mobile device a status of the second mobile device, wherein the status comprises one of the location of the second mobile device, an activity of the second mobile device, applications being executed by the second mobile device, and information associated with geo-fencing for the second mobile device.

3. The method of claim 1 further comprising locking access to one or more software applications executing on the processor of the second computing device.

4. The method of claim 2

5. The method of claim 1 further comprising presenting by the processor of the first mobile device a visual slider associated with activity of the second mobile device.

6. The method of claim 1 further comprising monitoring by the processor of the first mobile device the activity of the second mobile device in real-time or substantially real-time.

7. The method of claim 1 further comprising controlling access to one or more applications executing on the processor of the second mobile device by the processor of the first computing device based on one of timing, schedule, location, geo-location and usage.

8. The method of claim 1 wherein the processor of the first mobile device and the processor of the second computing device are in communication with a cloud platform.

9. The method of claim 1 further comprising sending by the processor of the second mobile device a Short Message Service (SMS) to first mobile device indicating a location of the second mobile device when second mobile device is not in communication with a network.

10. The method of claim 1 further comprising approving by the processor a third mobile device to be in communication with the second mobile device.

11. The method of claim 1 further comprising accessing one or more SMS messages present on the second mobile device by the processor of the first mobile device.

12. A system for controlling a second mobile device from a first mobile device, the system comprising: one or more processors; and a machine-readable medium comprising instructions stored therein, which when executed by the processors, cause the processors to perform operations comprising: receiving by a processor of the first mobile device a request to approve a contact transmitted by the second mobile device, approving by the processor of the first computing device the contact by pushing the approval to a processor of the second computing device; monitoring by the processor of the first mobile device an amount of time that the contact is in communication with the second mobile device; and adding a second contact by the processor of the first mobile device directly to the second mobile device from the first mobile device.

13. The system of claim 12 further comprising requesting by the processor of the first mobile device a status of the second mobile device, wherein the status comprises one of the location of the second mobile device, an activity of the second mobile device, applications being executed by the second mobile device, and information associated with geo-fencing for the second mobile device.

14. The system of claim 12 further comprising further comprising locking access to one or more software applications executing on the processor of the second computing device.

15. The system of claim 12 further comprising presenting by the processor of the first mobile device a visual slider associated with activity of the second mobile device.

16. The system of claim 12 further comprising monitoring by the processor of the first mobile device the activity of the second mobile device in real-time or substantially real-time.

17. The system of claim 1 further comprising controlling access to one or more applications executing on the processor of the second mobile device by the processor of the first computing device based on one of location, geo-location, timing, schedule, and usage.

18. The system of claim 12 wherein the processor of the first mobile device and the processor of the second computing device are in communication with a cloud platform.

19. The system of claim 12 further comprising sending by the processor of the second mobile device a Short Message Service (SMS) to first mobile device indicating a location of the second mobile device when second mobile device is not in communication with a network.

20. The system of claim 12 further comprising approving by the processor a third mobile device to be in communication with the second mobile device.

21. The system of claim 12 further comprising accessing one or more SMS messages present on the second mobile device by the processor of the first mobile device.
